(19) United States
(12) Patent Application Publication
(10) Pub. No.: US 2006/0193050 A1
(43) Pub. Date: Aug. 31, 2006

(54) Retroreflector, display device, and manufacturing method for retroreflector

(75) Inventors: Yutaka Sawayama, Nabari-shi (JP); Kiyoshi Minoura, Nara-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/328,465

(22) Filed: Jan. 10, 2006

(30) Foreign Application Priority Data
Jan. 14, 2005 (JP) 2005-007460

(51) Int. Cl. G02B 5/122

(52) U.S. Cl. 359/529

(57) ABSTRACT

A depressed triangular array contains a non-retroreflecting region and a retroreflecting region both of which have a planimetrically identical hexagon unit structure (non-retroreflecting unit, retroreflecting unit). When the non-retroreflecting units are removed from the depressed triangular array, the resulting array has a retroreflecting units S and void portions. A retroreflector of the present invention is produced by placing the retroreflecting units S in these void portions. Therefore, the retroreflector has a surface made up of closely packed retroreflecting units S. In other words, the whole surface area of the retroreflector is constituted of the retroreflecting units S, making the whole plane function as a retroreflecting region. Because of this structure, the retroreflector has a significantly high retroreflectance.

This Nonprovisional application claims priority under 35 U.S.C. § 119(a) on Patent Application No. 007460/2005 filed in Japan on Jan. 14, 2005, the entire contents of which are hereby incorporated by reference.

### FIELD OF THE INVENTION

The present invention relates to a retroreflector, which is used for a reflective display element or the like.

### BACKGROUND OF THE INVENTION

One of well-known conventional displays is a reflective liquid crystal display device (reflective LCD) which carries out display using ambient light (external light) as a light source.

Unlike a transmissive liquid crystal display device (transmissive LCD), the reflective LCD does not use a backlight (built-in light source). Therefore, no power for back light is required, and the battery can be miniaturized. Moreover, the size and weight of device can be reduced.

With these advantages, the reflective LCD is useful for a small and light-weighted display device.

As another advantage due to omission of back light, the reflective LCD has an extra space, which allows a battery area to be enlarged. The use of a larger battery will help great increase in operation time.

In addition to this, a reflective LCD has a superior contrast property for the display image in bright environment (e.g. outside in the daytime) compared to the other types of display device.

For example, a CRT, which is a luminous display device, causes a great decrease in contrast ratio in outside in the daytime.

Similarly, a transmissive LCD having been processed by low reflection treatment also causes a great decrease in contrast ratio when the ambient light (e.g. direct sunlight) is much stronger than the display light (light from the backlight).

On the other hand, the display light of a reflective LCD is proportional to the amount of ambient light, and therefore is immune to decrease in contrast ratio even under very strong ambient light.

Therefore, the reflective LCD is suitable for a device for frequent external usage, such as a mobile information terminal device (mobile phone), a digital camera, a mobile video camera, etc.

However, though there are many application fields in which its usefulness is guarantied, a truly practical color reflective LCD has never been made.

This derives from an insufficiency in display luminance of reflective LCD under dark environment.

The Japanese Unexamined Patent Publication No. Tokukai 2002-107519 (published on Apr. 10, 2002: corresponding U.S. patent publication U.S. Pat. No. 6,657,766; hereinafter referred to as Document 1) discloses a structure combining a scatter-type liquid display mode and a retroreflector, as a color reflective LCD with a superior display performance.

FIGS. 26(a) and 26(b) are explanatory views showing operation principle of a display device having the foregoing structure. The figures respectively show a black display state and a white display state of the display device.

In the black display state of display device shown in FIG. 26(a), the liquid crystal layer 101 of the display device is set to transmit light. In this state, the light incident on the display device transmits through the liquid crystal layer 101 and is reflected by a retroreflector 102 to the direction same as that it is incident on, i.e., it enters and returns in the same path (retroreflection light). Therefore, the light incident obliquely to the display device from the external light source 103 goes back to the light source 103 as a result of reflection, and therefore the light is out of sight of the observer P in front of the device.

Note that, in this case, the image received from the display device is eyes (cornea) of the user, that is, the screen shows “black” (black display).

In the white display state of display device shown in FIG. 26(b), the liquid crystal layer 101 of the display device is set to diffuse light. In this state, the light incident on the display device is diffused by the liquid crystal layer 101. Then, if the liquid crystal layer 101 is a forward-diffusion-type liquid crystal, the diffused light is reflected by the retroreflector 102 and is emitted outside through the liquid crystal layer 101 in a diffused state.

As in the case above, when the liquid crystal has a diffused state, the incident light is diffused to the multiple directions, and the retroreflecting characteristic of the retroreflector is abolished. Therefore, instead of returning to the light source, the incident light is emitted toward the observer, and the screen shows “white” (white display).

With such a display principle, the black/white display is realized without a polarizing element, and therefore the decrease in light usage efficiency due to the polarizing element does not occur, ensuring high brightness of reflective LCD.

Note that, in addition to various display devices (which perform display), the retroreflector is also used for a road sign or the like. The manufacturing method of this retroreflector is disclosed in US Patent Publication No. 4576850 (published on Mar. 18, 1986: hereinafter referred to as Document 2) or in Japanese Examined Patent Publication No. 2000-509166 (published on Jul. 18, 2000: International publication number Wo97/41464; hereinafter referred to as Document 3).

The retroreflector disclosed in the foregoing publications is made of a depressed-triangular-pyramid prism array, which is shown in FIG. 27.

The triangular-pyramid prism array has a structure in which the same sized triangular pyramids (depressions) are aligned closely (a plurality of depressed triangular-pyramids are aligned in a plane at a maximum density with the apices pointing downward).

This triangular-prism array can be manufactured as follows.

First, as shown in FIG. 28(a), a plate is processed (cut) by a machine in three directions with 120° differences to each other with respect to the plate, forming a plate (base board) with a “V-shaped groove”. As a result, as shown in FIG. 28(b), a base board in which the projecting-triangular-pyramids are aligned closely (projecting-triangular-pyramid prism array: a plurality of triangular-pyramid-projections are aligned in a plane at a maximum density) is formed.

Next, as shown in Figure (c), the grooves of the base board are transferred onto a material of retroreflector, forming the inverted patterns on the base board. Then, a high-reflection metal film (an Ag (silver) or the like) is formed on the plane (surface) on which the triangular-pyramids are formed. Consequently, a depressed triangular-pyramid prism array is completed.

Note that, in FIGS. 28(b) through (d), ∘ and ● respectively denote the apex and the bottom apex of triangular-pyramid.

In the surface (high-reflection metal film) on which the triangular-pyramids are formed, the depressed triangular-pyramid prism array is disposed in a position where it reflects light, so as to function as a retroreflector.

More specifically, the light incident on one of the three planes around a bottom apex is reflected by each plane and is reflected (returned) toward the incident direction.

Note that, by forming a base board (projecting triangular-pyramid prism array) with a transparent resin material or the like, the base board itself can serve as a retroreflector (FIG. 28(d)). In this case, the incident light is reflected by an interface between the resin material and air, and the observer sees the rear surface (the flat plane) of board. That is, in this structure, the light incident on one of the three planes around the apex is reflected by each plane and is reflected toward the incident direction.

As for the retroreflector used as a reflector of a reflective LCD, like the one disclosed in Document1, a higher retroreflectance (ratio of light subjected to retroreflection among the light incident on the retroreflector) is preferred. The high retroreflectance increases the contrast ratio in display, and therefore reduces unnecessary extra light emitted to the observer in the black display.

However, because of its structure, the region contributing to retroreflection in the triangular-pyramid prism array is a hexagonal region around a center (points denoted by ∘ and ● in FIGS. 28(c) and (d)) of each triangular-pyramid, as shown in FIG. 29.

As shown in FIG. 30, the remaining region (non-retroreflection region) does not have the third reflection surface, and therefore does not function as a retroreflection region.

The non-retroreflection region forms an equilateral triangle at each of the three corners in the bottom of the respective triangular-pyramid. The respective non-retroreflection areas of six adjacent triangular-pyramids are gathered to a certain corner, and therefore, when viewed as a plain, they form the same hexagons as those in the retroreflection region.

That is, the effective planer dimension (the planar dimension of region contributing to retroreflection) of the triangular-pyramid prism array is ⅔ with reflect to the whole area. More specifically, the light incident on the remaining (⅓) non-retroreflection region is not subjected to retroreflection but diffused. For this reason, the retroreflectance of the triangular-pyramid prism array cannot be more than ⅔ (66.7%).

Because of this principle, when a triangular-pyramid prism array is used as a reflector for a display device, as shown in FIGS. 26(a) and 26(b), one third of the region does not contribute to retroreflection (i.e., one third of the area is a light diffusion region). Because of this, degradation in black level is unavoidable. As it also causes a decrease in brightness of white display, the degree of display contrast cannot reach a sufficient level, and the display quality decreases.

### SUMMARY OF THE INVENTION

An object of the present invention is to provide a retroreflector having high retroreflectance.

In order to attain the foregoing object, the present invention provides a retroreflector which reflects incident light back along an incident path, wherein a light reflecting surface of the retroreflector is defined by a configuration of closely packed retroreflecting units of a depressed triangular array.

The reflector of the present invention, which is used for a reflective display device (e.g. liquid crystal display device) or the like, reflects incident light back along an incident path (so that the light goes back along the incident path).

As a particularly notable feature, the reflector of the present invention is arranged so that a light reflecting surface of the retroreflector is defined by a configuration of closely packed retroreflecting units of a depressed triangular prism array (depressed triangular array).

That is, the depressed triangular array is made up of closely packed depressed triangular pyramid prism (depressed triangles) (in other words, hollow triangular-prisms are closely packed on a plane with the apices pointing downward).

Further, as described, ⅓ of the light reflecting surface of the triangular-pyramid array functions as the non-retroreflection region and ⅔ thereof functions as the retroreflection region.

More specifically, in the depressed triangular array, a hexagon region around the bottom apex of a triangular pyramid forms a unit structure (retroreflecting unit) of the retroreflecting region.

Further, the retroreflecting unit is constituted of three pentagons each having an apex angle of 90°.

Meanwhile, the non-retroreflecting area of the depressed triangle array is constituted of a unit structure (non-retroreflecting unit) around the junction of adjacent six depressed triangles (their apices are in contact with each other). The non-retroreflecting area is a hexagon congruent to the retroreflecting unit in a plan view (when the depressed triangular array is viewed from the normal direction).

Therefore, the depressed triangular array can be expressed as a structure made up of closely packed non-retroreflecting unit and the retroreflecting unit both having a hexagon shape.

Here, by removing the non-retroreflecting unit from the depressed triangular array, the array becomes a configuration made up of retroreflecting units and void portions.

Further, placing the retroreflecting units in the portions of the depressed triangular array from which non-retroreflecting regions have been removed produces the reflector of the present invention, which is entirely constituted of retroreflecting units.

With this configuration, the retroreflector of the present invention has a surface made up of closely packed retroreflecting units of the depressed triangular array. That is, in the retroreflector of the present invention, the entire surface is constituted of retroreflecting units, in other words, the entire surface functions as a retroreflecting region.

The retroreflector of the present invention therefore has a significantly high retroreflectance.

The following steps (4-1) through (4-3) are an example of manufacturing method of such a retroreflector.

(4-1) forming a resist only in non-retroreflecting regions of a protruding triangular array in which protruding triangles are closely packed together;

(4-2) filling a transfer material between the resists formed on the protruding triangular array, so as to transfer and form a plurality of retroreflecting unit columns having the same end face configuration as retroreflecting units; and

(4-3) closely packing the retroreflecting unit columns with the end faces aligned together.

Here, the projecting triangle array is obtained by transferring the depressed triangle array. Further, the non-retroreflecting region of the projecting triangle array denotes a portion which becomes a retroreflecting unit of the depressed triangle array when transferred. Similarly, the non-retroreflecting region of the projecting triangle array denotes a portion which becomes a non-retroreflecting unit of the depressed triangle array when transferred.

In the step (4-1) the non-retroreflecting region of the projecting triangular array is covered by resist. Then, in the subsequent step (4-2) the retroreflecting region having no resist in the projecting triangular array is filled with a transfer material. The transfer material is then hardened to become a hexagon column (retroreflecting unit column) which contains an end face of the transferred shape (the retroreflecting unit) of the retroreflecting unit of the projecting triangular array.

Therefore, as shown in the step (4-3), a plurality of retroreflecting unit columns are formed, and then closely packed by joining their end faces, thereby forming a retroreflector whose entire reflection surface functions as a retroreflecting unit.

The following steps (5-1) through (5-3) are another example of manufacturing method of the retroreflector.

(5-1) forming a first retroreflecting unit array in which retroreflecting unit columns having the same end face configuration as retroreflecting units of a depressed triangular array are arranged in the same layout as the retroreflecting units of the depressed triangular array, and in which voids are formed between the retroreflecting unit columns;

(5-2) forming a transfer array in which protruding hexagonal columns having the same end face configuration as a retroreflecting region of a protruding triangular array are arranged in the same layout as non-retroreflecting units of the depressed triangular array; and

(5-3) transferring the end face configuration of the protruding hexagonal columns of the transfer array to an end face of a transfer material placed in the voids of the first retroreflecting array, so as to form retroreflecting units.

In this method, the step (5-1) first forms an array (first retroreflecting unit array), that is a depressed triangular array, but the non-retroreflecting units are all removed.

As a concrete example, the first retroreflecting array is formed by a transfer process, in which a resist is formed only in non-retroreflecting regions of a protruding triangular array, and in which a transfer material is filled between the resists.

Then, the step (5-2) forms a transfer array constituted of projecting hexagon columns having the same end faces as those of the retroreflecting regions of the projecting triangular array.

As a concrete example, the transfer array is formed by a transfer process, in which a resist is formed only in regions of the depressed triangular array other than the retroreflecting units corresponding to the layout of the non-retroreflecting units of the depressed triangular array.

Next, in the step (5-3), the end face shape of the projecting hexagon column of transfer array is transferred to the end face of the transfer material placed in the void of the first retroreflecting unit array. As a result, the end faces of the transfer materials between the respective retroreflecting unit columns also function as retroreflecting units, making the entire surface of the first retroreflecting unit array function as a retroreflecting unit.

In this method, the retroreflector of the present invention is formed by combining a retroreflection unit column and the transfer array. This method is much simpler and speedy than the method of joining separate retroreflecting units.

The following steps (12-1) through (12-3) are still another example of manufacturing method of such a retroreflector.

(12-1) forming a first retroreflecting unit array in which retroreflecting unit columns having the same end face configuration as retroreflecting units of a depressed triangular array are arranged in the same layout as the retroreflecting units of the depressed triangular array, and in which voids are formed between the retroreflecting unit columns;

(12-2) forming a plurality of retroreflecting unit columns having the same end face configuration as the retroreflecting units; and

(12-3) inserting the retroreflecting unit columns formed in said step (12-2) into the voids of the first retroreflecting unit columns.

In this method, the retroreflector of the present invention is formed by inserting a retroreflecting unit column into the void portion of the first retroreflecting unit array. Therefore, the transfer array is not used, and therefore the leakage of transfer material does not occur. Further, the height of the retroreflecting unit does not need to be adjusted.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is an explanatory view of a structure of a retroreflector according to one embodiment of the present invention.

FIG. 2 is a cross sectional view showing a structure of liquid crystal display device according to one embodiment of the present invention.

FIG. 3 is an explanatory view of a depressed triangular array.

FIG. 4 is a perspective view of the depressed triangular array shown in FIG. 3.

FIG. 5(a) is a perspective view of the depressed triangular array shown in FIG. 3.

FIG. 5(b) is an explanatory view of a pentagon constituting a retroreflecting unit of a depressed triangular array.

FIG. 6 is an explanatory view of an array made up of retroreflecting unit and a void portion, that is formed by removing the non-retroreflecting unit of a depressed triangular array.

FIG. 7 is a perspective view of the retroreflector shown in FIG. 1.

FIGS. 8(a) through 8(f) are upper views showing a manufacturing step of retroreflector.

FIGS. 8(g) through 8(l) are cross sectional views corresponding to the manufacturing steps shown in FIGS. 8(a) through 8(f).

FIG. 9 is an upper view showing a manufacturing process of retroreflector.

FIG. 10 is an explanatory view showing a test device for measuring retroreflectance of retroreflector.

FIGS. 11(a) through 11(c) are upper views showing a manufacturing process of retroreflector.

FIG. 11(d) is an explanatory view of a structure of photomask used in the manufacturing processes 11(a) through 11(c).

FIGS. 12(a) through 12(c) are upper views showing a manufacturing process of retroreflector.

FIG. 12(d) is an explanatory view of a structure of photomask used in the manufacturing processes 12(a) through 12(c).

FIGS. 13(a) and 13(b) are explanatory views of layouts of the retroreflecting unit and the non-retroreflecting unit of a depressed triangular array.

FIGS. 14(a) through 14(e) are explanatory views showing a manufacturing process of retroreflector.

FIGS. 15(a) and 15(b) are perspective and upper views of the non-retroreflecting unit of depressed triangular array shown in FIG. 4.

FIGS. 15(c) and 15(d) are perspective and upper views of a retroreflecting unit.

FIG. 16 is an explanatory view showing a gap (void), which tends to be generated in the retroreflector shown in FIG. 1.

FIG. 17(a) and 17(b) are upper and cross sectional views of a surface (the retroreflecting region of projecting triangle) of the projecting hexagon column shown in FIG. 12(c).

FIG. 18 is an explanatory view of a gap generated in the manufacturing process shown in FIGS. 14(a) through 14(e).

FIG. 19 is a cross sectional view showing a manufacturing process of retroreflector.

FIG. 20 is a cross sectional view showing a defect generated in the manufacturing process of retroreflector.

FIG. 21 is a cross sectional view showing a manufacturing process of retroreflector.

FIGS. 22(a) through 22(c) are explanatory views of a manufacturing process of retroreflector.

FIGS. 23(a) and 23(b) are explanatory views showing a bite pitch in fabrication of a depressed triangular array.

FIGS. 24(a) through 24(e) are explanatory views of a manufacturing process of retroreflector.

FIGS. 25(a) and 25(b) are explanatory views of a manufacturing process of retroreflector.

FIGS. 26(a) and 26(b) are explanatory views of operation principle of display device using a combination of a scatter-type liquid display mode and a retroreflector.

FIG. 27 is an explanatory view of a triangular pyramid prism array.

FIGS. 28(a) through 28(d) are explanatory views of formation process and result of the triangular pyramid prism array.

FIG. 29 is an explanatory view of a retroreflecting region and a non-retroreflecting region of triangular pyramid prism array.

FIG. 30 is an explanatory view of a retroreflecting region and a non-retroreflecting region of triangular pyramid prism array.

### DESCRIPTION OF THE EMBODIMENTS

The following will describe one embodiment of the present invention with reference to the attached drawings.

A liquid crystal display device according to the present embodiment (present display device) is a reflective liquid crystal display device that uses external light to perform display.

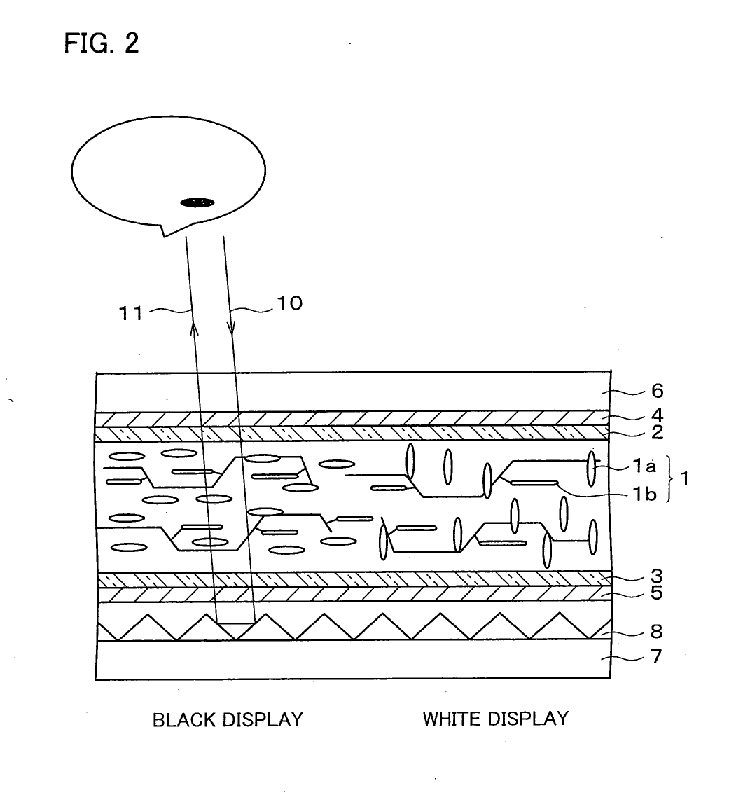

FIG. 2 is a cross sectional view illustrating a structure of the present display device.

As illustrated in FIG. 2, the present display device is structured to include an incident-side substrate 6 and a reflection-side substrate 7, and a liquid crystal layer (switching layer) 1 disposed in between.

The incident-side substrate 6 is made of a material such as a transparent glass plate or a polymer film. The reflection-side substrate 7 is also made of a glass plate, a polymer film, or the like, but may not be transparent.

On the reflection-side substrate 7 is formed a retroreflector 8 for reflecting incident light toward the incident-side substrate 6. On the retroreflector 8, incident light through the incident-side substrate 6 is reflected in a direction parallel to the incident light.

The incident-side substrate 6 and the reflection-side substrate 7 have electrode 4 and electrode 5, respectively for applying voltage to the liquid crystal layer 1.

The electrodes 4 and 5 are used to apply voltage to each pixel of the liquid crystal layer 1. The surfaces of the electrodes 4 and 5 facing the liquid crystal layer 1 are respectively coated with horizontal alignment films 2 and 3 in contact with the liquid crystal layer 1. The horizontal alignment films 2 and 3 are set so that the liquid crystal layer 1 has a horizontally aligned state under no applied voltage.

The liquid crystal layer 1 includes diffused-type liquid crystal, which is switched between a transmissive state and a diffused state.

As used herein, the “transmissive state” refers to a state in which a propagation direction of incident light is maintained. (This includes the case where incident light is refracted in the course of its travel.) The “diffused state” refers to a state in which a propagation direction of incident light is changed (light is diffused).

As the material of the liquid crystal layer 1, polymer dispersed-type liquid crystal may be used. In this case, for example, a homogenous mixture dissolving a low-molecular-weight liquid crystal composition and an unpolymerized prepolymer (prepolymer liquid crystal composition) is placed between the substrates, and the prepolymer is polymerized to obtain the liquid crystal layer 1.

The following describes a display principle of the present display device.

First, a white display operation is described. In response to an applied voltage to the liquid crystal layer 1, liquid crystal molecules la of the liquid crystal layer 1 are directed along the direction of the electric field while the direction of polymer liquid crystal anchors 1b remains the same. By the difference in refractive index between these two liquid crystal components, the liquid crystal layer 1 assumes the diffused state.

Light incident on the liquid crystal layer 1 of the diffused state passes through the liquid crystal layer 1 as straight light or forward-diffused light. The light is then reflected off the retroreflector 8, and is diffused as it travels back through the liquid crystal layer 1 of the diffused state. As a result, a large quantity of light returns to the viewer, in addition to the back-diffused light.

Because the straight light and forward-diffused light passing through the liquid crystal layer 1 are used in addition to the back-diffused light, a highly bright display can be obtained. Note that, each liquid crystal molecule la is separated from the polymer liquid crystal anchors 1b by a predetermined distance.

The following describes a black display.

Under no applied voltage, the liquid crystal molecules 1a of the liquid crystal layer 1 are directed along the polymer liquid crystal anchors 1b. Because the refractive index is the same between these two liquid crystal components, the liquid crystal layer 1 assumes the transmissive state.

Here, the light that enters the observer's eye follows the following path. First, the light is refracted by display device components, including the light-incident substrate 6 and the liquid crystal layer 1. The light is then retroreflected by the retroreflector 8 and refracted again by the light-incident substrate 6 and the liquid crystal layer 1, before it reaches the observer in the very vicinity of his/her eye.

That is, only incident light 10 that falls from the vicinity of the observer's eye becomes emergent light 11 to the observer. Here, assuming that no light source exists in the vicinity of the observer's eye, no emergent light 11 exists and the observer sees a black image.

In the following, description is made as to the retroreflector 8 of the present display device.

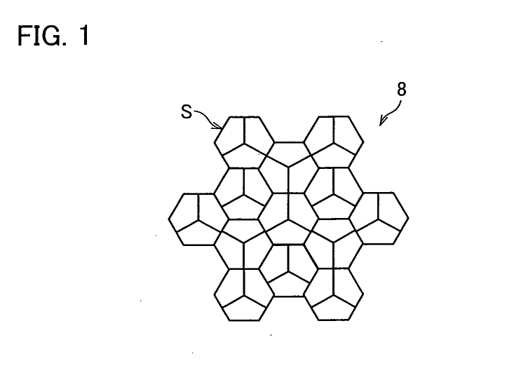

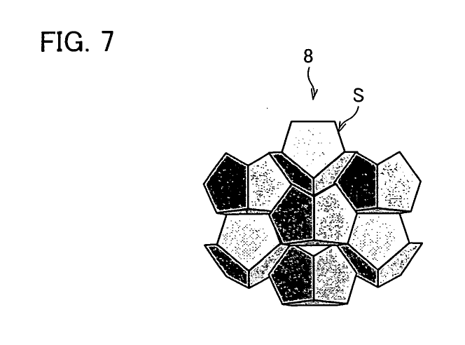

FIG. 1 is an explanatory view depicting a structure of the retroreflector 8. FIG. 7 is a perspective view of the retroreflector 8.

As shown in FIGS. 1 and 7, the retroreflector 8 has a depressed triangular-pyramid prism array structure (depressed triangular array) with closely packed retroreflecting regions (the retroreflecting regions being embedded in portions of the depressed triangular array from which non-retroreflecting regions have been removed).

The structure of the retroreflector 8 is described below in more detail.

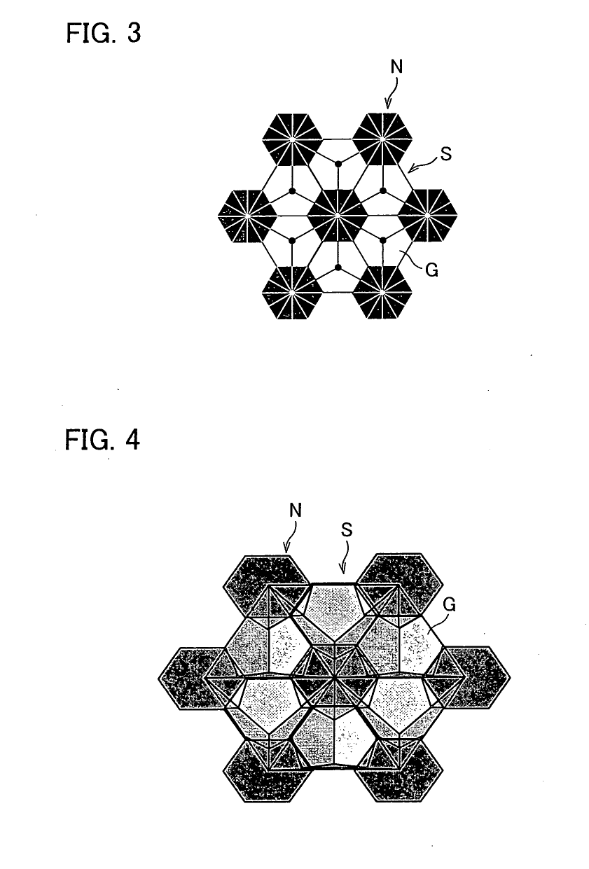

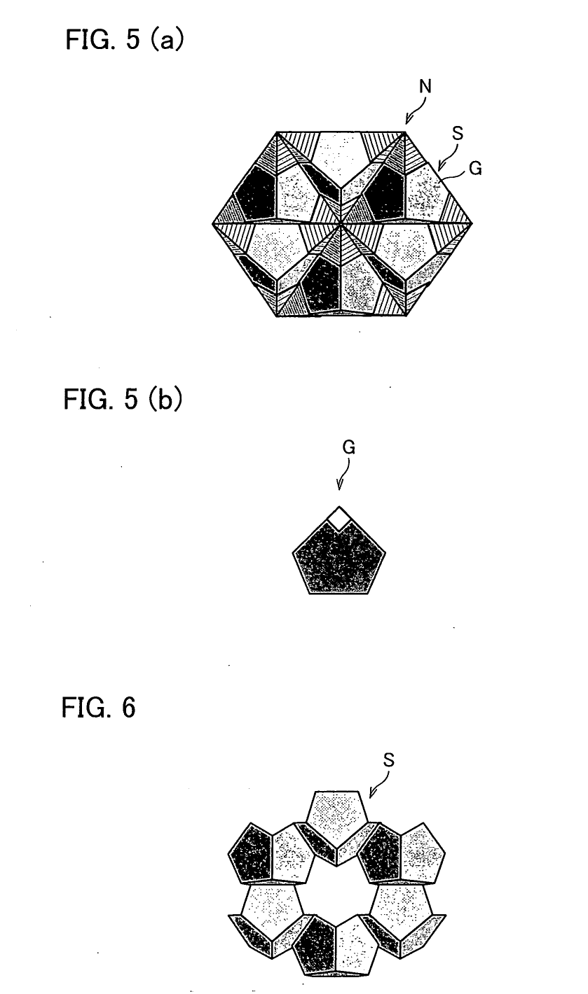

FIG. 3 is an explanatory view depicting the depressed triangular array. FIG. 4 and FIG. 5(a) are perspective views of the depressed triangular array shown in FIG. 3.

The array includes depressed triangular-pyramid prisms (depressed triangles) closely packed together (hollow triangular-prisms closely packed together with the apices pointing downward on a plane). In using the array as the retroreflector, the array is made of metal, or a highly reflective metal film is formed inside the hollow depressed triangles.

Further, as described above, one-third of the reflecting surface of the depressed triangular array are the non-retroreflecting regions, while the other two-thirds are the retroreflecting regions.

Specifically, as shown in FIG. 3, the hexagonal region having the center at the bottom apex (●) of each triangular pyramid in the depressed triangular array is the unit structure (retroreflecting unit S) of the retroreflecting regions.

The retroreflecting unit S is made up of three pentagons G each having the apex angle (angle defining the bottom apex) of 90°, as shown in FIG. 5(b).

The non-retroreflecting regions have the unit structure (non-retroreflecting unit N) having the center at the point of contact between six adjoining depressed triangles (adjoined at angles). On a two-dimensional plane (when viewed in the direction normal to the depressed triangular array), the non-retroreflecting unit N is a hexagon congruent to the retroreflecting unit S.

Therefore, the depressed triangular array can be described as having hexagonal non-retroreflecting unit N and hexagonal retroreflecting unit S closely packed together.

Removing the non-retroreflecting unit N from the depressed triangular array produces an array with the retroreflecting unit S and a void portion, as shown in FIG. 6.

Placing the retroreflecting unit S in the void portion of the array (where the non-retroreflecting unit N was present) as shown in FIG. 6 produces the retroreflector 8 of the present display device as shown in the perspective view of FIG. 7, and the top plan view of FIG. 1.

As described above, the retroreflector 8 has a surface with the retroreflecting units S of the depressed triangular array closely packed together. Since the entire surface area is occupied by the retroreflecting units S, the retroreflector 8 has the retroreflecting region over its entire surface.

The retroreflector 8 therefore has a significantly high retroreflectance.

The following will describe a manufacturing method of the retroreflector 8.

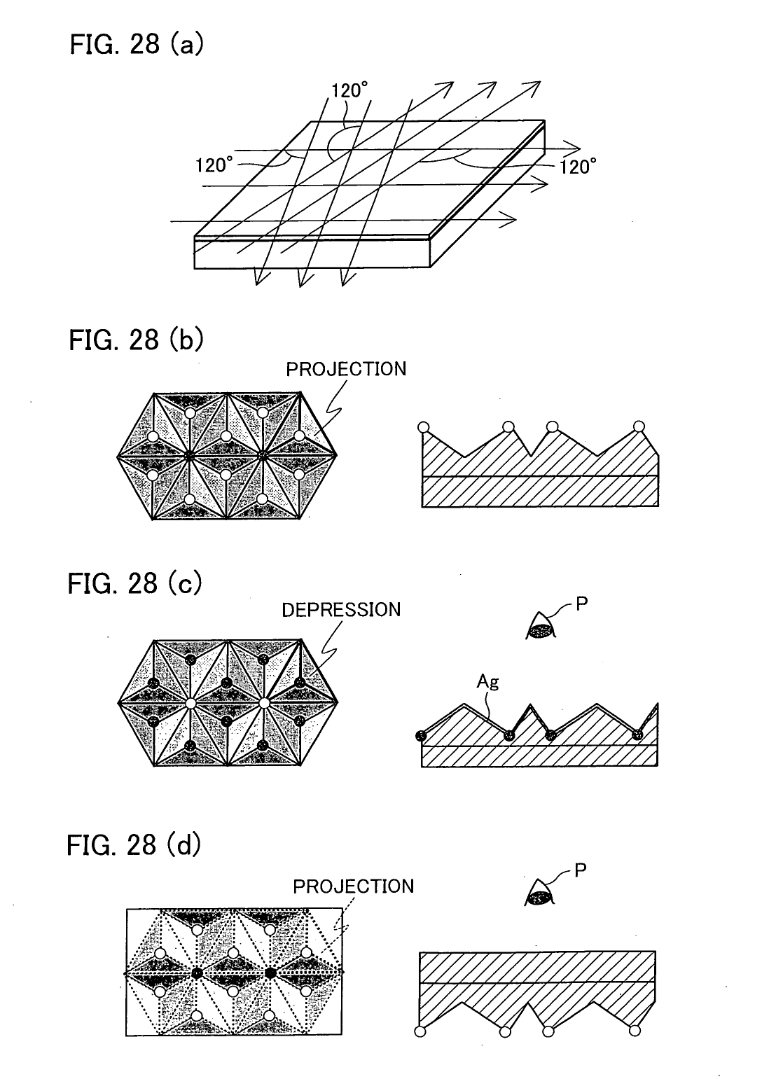

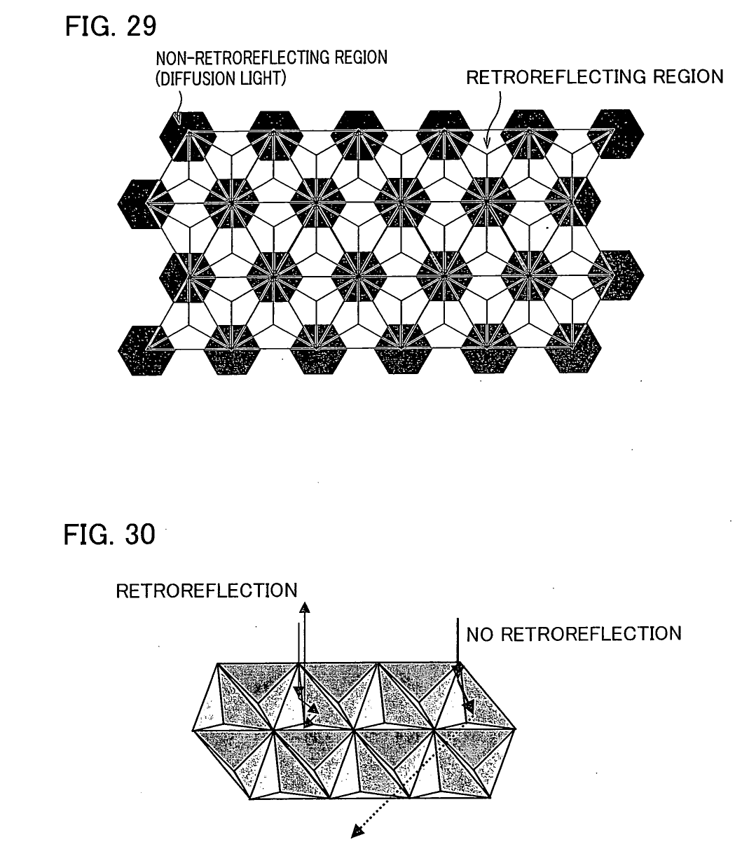

The retroreflecting unit S has the shape obtained by transferring one of the retroreflecting regions (a hexagonal region with the center at the apex of one of the protruding triangular-pyramid prism (protruding triangle)) of the protruding triangular-pyramid prism array (protruding triangular array) which is obtained by the cutting process illustrated in FIG. 28(a).

Specifically, the retroreflecting unit S is obtained by masking the non-retroreflecting region of the protruding triangular array, and then transferring one of the retroreflecting regions onto a transfer material (resin, plating material, for example).

As used herein, “one of the retroreflecting regions” of the protruding triangular array refers to a region which becomes the retroreflecting unit S of the depressed triangular array upon transfer. Likewise, the “non-retroreflecting region” of the protruding triangular array refers to a region which becomes the non-retroreflecting unit N of the depressed triangular array upon transfer.

In the following, one of the retroreflecting regions (non-retroreflecting region) of the protruding triangular array will be referred to as a protruding retroreflecting unit (protruding non-retroreflecting unit).

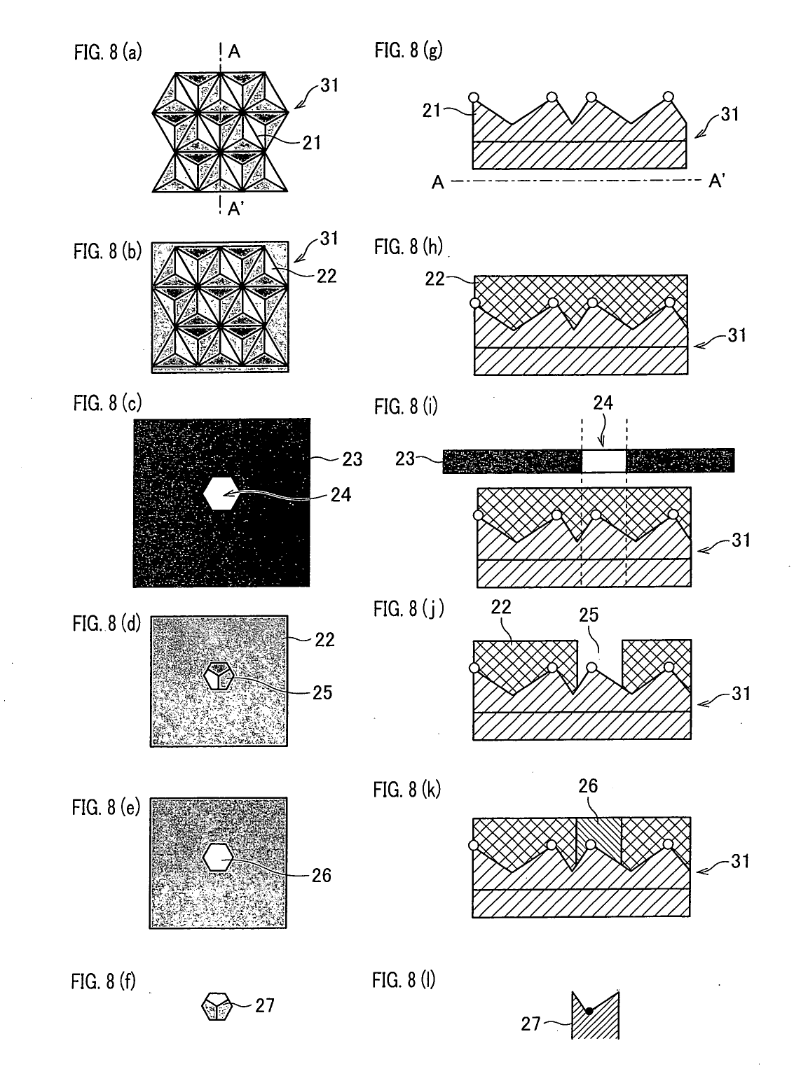

FIGS. 8(a) through 8(f) are plan views showing manufacturing steps of the retroreflector 8. FIGS. 8(g) through 8(l) are cross sectional views respectively corresponding to FIGS. 8(a) through 8(f).

In manufacturing the retroreflector 8, the protruding triangular array is formed first by machining (cutting) a flat board in three different directions with a 120° angle difference, as shown in FIG. 28(a) (Step 1).

As a result, a protruding triangular array 31 with closely packed protruding triangles 21 is formed, as shown in FIGS. 8(a) and 8(g).

As the substrate (flat board) used for machining, a 15 mm thick SUS with a plated Cu layer of 100 μm thick may be used.

As the cutting device, a NANO-100 (the product of Sodick) may be used with a diamond bite (apex angle: 70.5°, R: 0.1 μm).

In this case, the Cu layer of the substrate is cut in three directions with a bite pitch of 20 μm.

Thereafter, as shown in FIGS. 8(b) and 8(h), a photoresist 22 is formed on the protruding triangular array 31 (Step 2).

As the photoresist 22, a PMERP-LA900PM (positive-type, the product of Tokyo Ohka Co Ltd.) may be used, for example.

Next, as shown in FIGS. 8(c) and 8(i), the photoresist 22 is exposed through a photomask 23 and developed (Step 3).

The photomask 23 has a hole 24 that is congruent to the planer configuration (hexagon) of the protruding retroreflecting unit. The hole 24 is aligned with the protruding retroreflecting unit.

As a result, an opening 25 is formed on the protruding retroreflecting unit, while the photoresist 22 remains in the other region, as shown in FIGS. 8(d) and 8(j).

Thereafter, as shown in FIGS. 8(e) and 8(k), an inverted pattern is formed by electrocasting (embedded plating), using the protruding triangular array 31, with the opening 25 and the photoresist 22, as a master (Step 4; plating material 26 is embedded in the opening 25).

The plating may be performed by an electroless plating method, using Ni—P on the master.

Thereafter, the photoresist 22 is released from the protruding triangular array 31 (resist removal). The plating material embedded in the opening 25 is then detached from the protruding triangular array 31 (Step 5).

As a result, a retroreflecting unit column 27 is obtained that is made out of the plating material 26 and having the same end face configuration as the retroreflecting unit S, as shown in FIGS. 8(f) and 8(l).

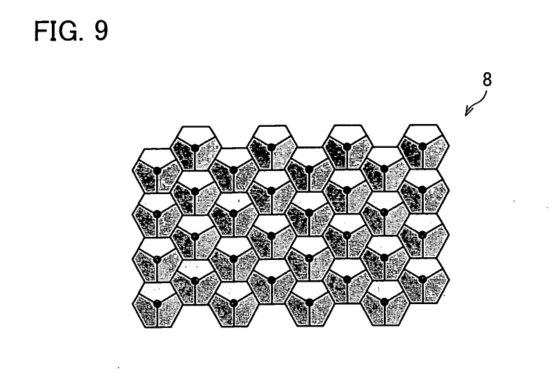

Next, as illustrated in FIG. 9, a plurality of retroreflecting unit columns 27 formed in this manner are closely packed together with their end faces, having the same configuration as the retroreflecting unit S, aligned together (Step 6).

As a result, the retroreflector 8, as shown in FIGS. 1 and 7 is obtained.

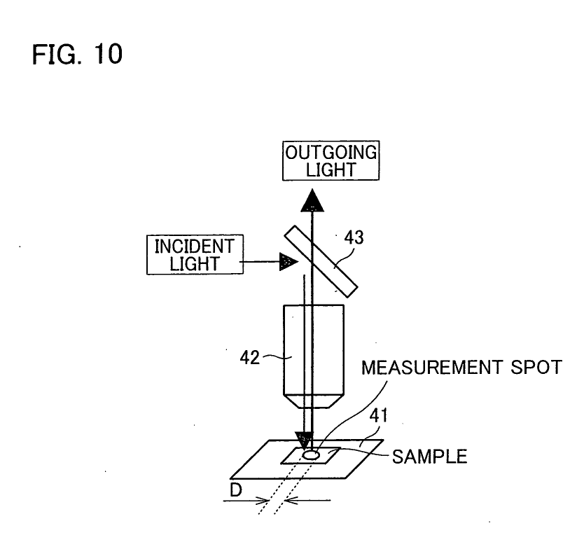

In the following description is made as to the measurement results of retroreflectance of the retroreflector 8. The measurement was performed with a test device similar to the incident-light microscope illustrated in FIG. 10.

The test device includes a sample stage 41 for holding a measurement sample, an objective lens 42, and a half mirror 43. The test device also includes a photoreceptor and a light source (emitting white light), though not shown.

The half mirror 43 is positioned such that the light emitted by the light source is reflected and perpendicularly incident on a sample held on the sample stage 41.

Specifically, the light emitted by the light source is reflected by the half mirror 43, and forms a light spot on the sample (measurement sample) as it passes through the objective lens 42 (converging angle of 7.5°, for example).

The reflected light from the sample passes through the objective lens 42 and the half mirror 43, and reaches the photoreceptor provided directly above the objective lens 42.

The test device was used for the measurement of retroreflectance of the retroreflector 8 and the depressed triangular array (comparative example).

Note that, the depressed triangular array used for the measurement was obtained by transferring the protruding triangular array obtained in Step 1 onto a plating material, using the array as a master.

Further, the machining precision of the retroreflector 8 and the depressed triangular array used for the measurement had been confirmed by a display test to be sufficient for display use, even when the test measured only the region (retroreflecting region) that retroreflects incident light.

Thus, the depressed triangular array used as a comparative example in the measurement can be sufficiently used as the retroreflector 8 of the present display device if it had the retroreflecting region over its entire surface.

The measurement showed that the retroreflector 8 had a retroreflectance 1.5 times greater than that of the depressed triangular array.

In the depressed triangular array actually used, the retroreflecting region occupied two-thirds of the total area (retroreflecting region=66.7%), while the other one-third diffused light (diffused light from this portion does not enter the objective lens 42 of the test device).

Therefore, it was found that the retroreflector 8 had the retroreflecting region substantially over its entire surface (retroreflecting region=100%).

As described above, the retroreflector 8 is obtained by closely packing a plurality of retroreflecting unit columns 27.

However, the retroreflector 8 is not just limited to such a structure and may be made from an arrayed material.

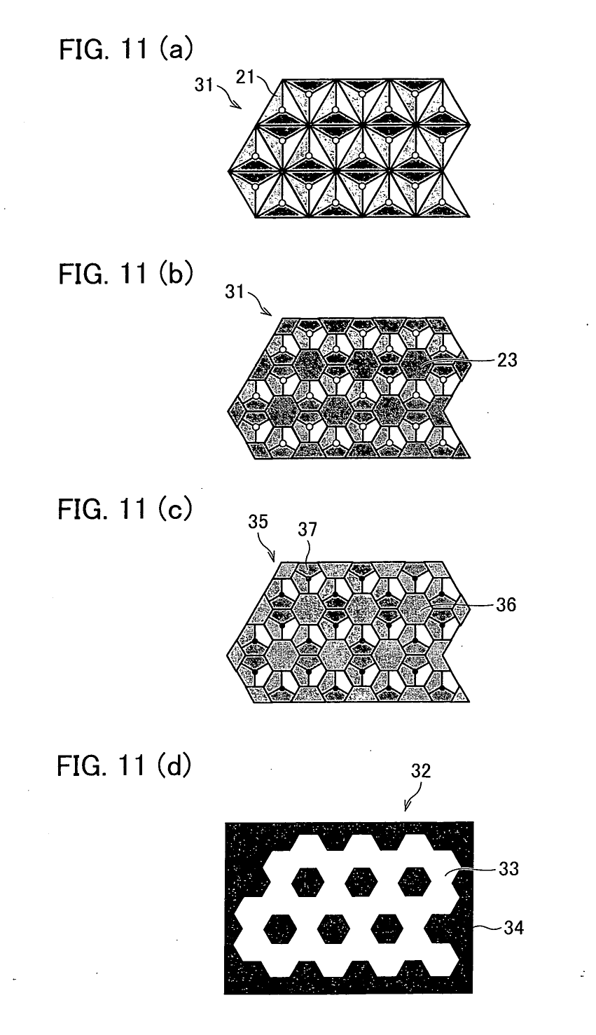

In this case, as in Step 1, a protruding triangular array 31 is formed that has protruding triangles 21 closely packed together, as shown in FIG. 11(a) (Step 11).

Thereafter, a photoresist (for example, PMERP-LA900PM (positive-type, the product of Tokyo Ohka Co Ltd.)) 22 is applied on the protruding triangular array 31. The photoresist 22 is then exposed through a photomask 32 and developed (Step 12).

FIG. 11(d) is a top view illustrating a structure of the photomask 32.

The photomask 32 has a light transmissive portion 33 (joining the holes 24) corresponding to a planer configuration (hexagon) of a plurality of protruding retroreflecting units of the protruding triangular array 31. (The remaining portion is a transmissive portion 34.)

The light transmissive portion 33 is then aligned with the protruding retroreflecting units of the protruding triangular array 31.

As a result, the photoresist 22 remains only on the protruding retroreflecting units, as shown in FIG. 11(b).

Next, as in Step 4, an inverted pattern is formed by electrocasting (embedded plating), using the protruding triangular array 31 with the photoresist 22 as a master (Step 13).

As a result, a first inverted pattern (retroreflecting unit array) 35 is obtained from the depressed triangular array, without the non-retroreflecting units N.

In portions corresponding to the retroreflecting units S of the depressed triangular array, the first inverted pattern 35 has retroreflecting unit columns 37 having the same end face as the retroreflecting units S and made out of a plating material.

The portions corresponding to the non-retroreflecting units N of the depressed triangular array are voids 36.

The retroreflectance of the first inverted pattern 35 was also measured with the test device described above (see FIG. 10). The result matched that of the ordinary depressed triangular array (see FIG. 3).

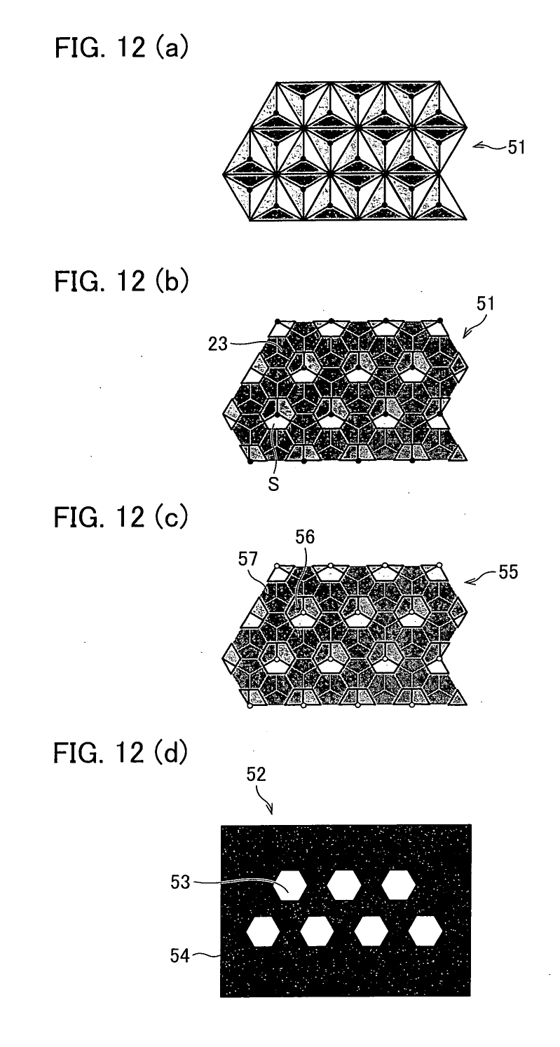

By resin transfer using the protruding triangular array 31 obtained in Step 11, a depressed triangular array 51 as shown in FIG. 12(a) is formed (Step 14).

As the resin material, a UV curable acrylic resin (MP-107, the product of Mitsubishi Rayon) is used. As the base plate used in resin transfer, a glass plate (1737 glass, Corning) is used.

Next, a photoresist is applied on the depressed triangular array 51. The photoresist is then exposed through a photomask 52, as shown in FIG. 12(d), and is developed (Step 15).

The photoresist 52 has a light transmissive region 53 corresponding to the layout (layout pattern) of the non-retroreflecting units of the depressed triangular array 51. (The other region is a light-shielding region 54.)

In the exposure, the photomask 52 is aligned with the retroreflecting units S of the depressed triangular array 51.

In the depressed triangular array, the non-retroreflecting units N and the retroreflecting units S have the same hexagonal planer configuration, as shown in FIG. 3.

Further, the retroreflecting units S are provided in number (layout density) twice as large as the non-retroreflecting units N. However, the layout of the retroreflecting units S subsumes that of the non-retroreflecting units N.

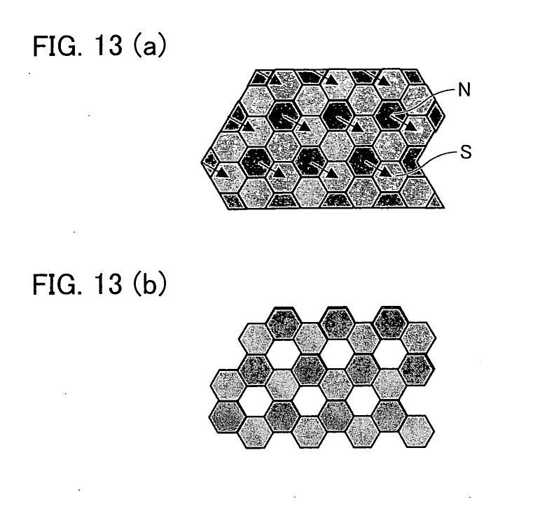

Specifically, in the depressed triangular array, the retroreflecting units S and the non-retroreflecting units N are arranged as shown in FIG. 13(a). Here, if parallel displacement of the non-retroreflecting units N were caused by one pitch (pitch of hexagons) in the direction of arrow shown in FIG. 13(a), then the non-retroreflecting units N would overlap with the retroreflecting units S, as shown in FIG. 13(b).

In this manner, the layout of the retroreflecting units S subsumes the layout of the non-retroreflecting units N. This enables the photomask 52, having the light transmissive region 53 corresponding to the layout of the non-retroreflecting units N, to be disposed according to the retroreflecting units S of the depressed triangular array 51.

By the exposure through the photomask 52, the resist 22 can be formed in regions other than the retroreflecting units S corresponding to the layout of the non-retroreflecting units N of the depressed triangular array 51, as shown in FIG. 12(b).

Next, by resin transfer using the depressed triangular array 51, a second inverted pattern (transfer array) 55 is formed, as shown in FIG. 12(c) (Step 16).

As the resin material, a UV curable acrylic resin (MP-107, the product of Mitsubishi Rayon) is used. As the base plate used for the resin transfer, a glass plate (1737 glass, Corning) is used.

As illustrated in FIG. 12(c), the second inverted pattern 55 has hexagonal columns (protruding hexagonal columns) 56 having the same surface configuration as the protruding retroreflecting units and the same layout as the non-retroreflecting units N of the depressed triangular array. The space between the protruding hexagonal columns 56 is occupied by voids 57.

Note that, the protruding hexagonal columns 56 of the second inverted pattern 55 have the same pitch and size as the void portions 36 of the first inverted pattern 35.

The retroreflectance of the second inverted pattern 55 (more specifically, the retroreflectance of the inverted pattern of the second inverted pattern 55) was also measured with the test device shown in FIG. 10. The result was half the retroreflectance of the ordinary depressed triangular array (see FIG. 3).

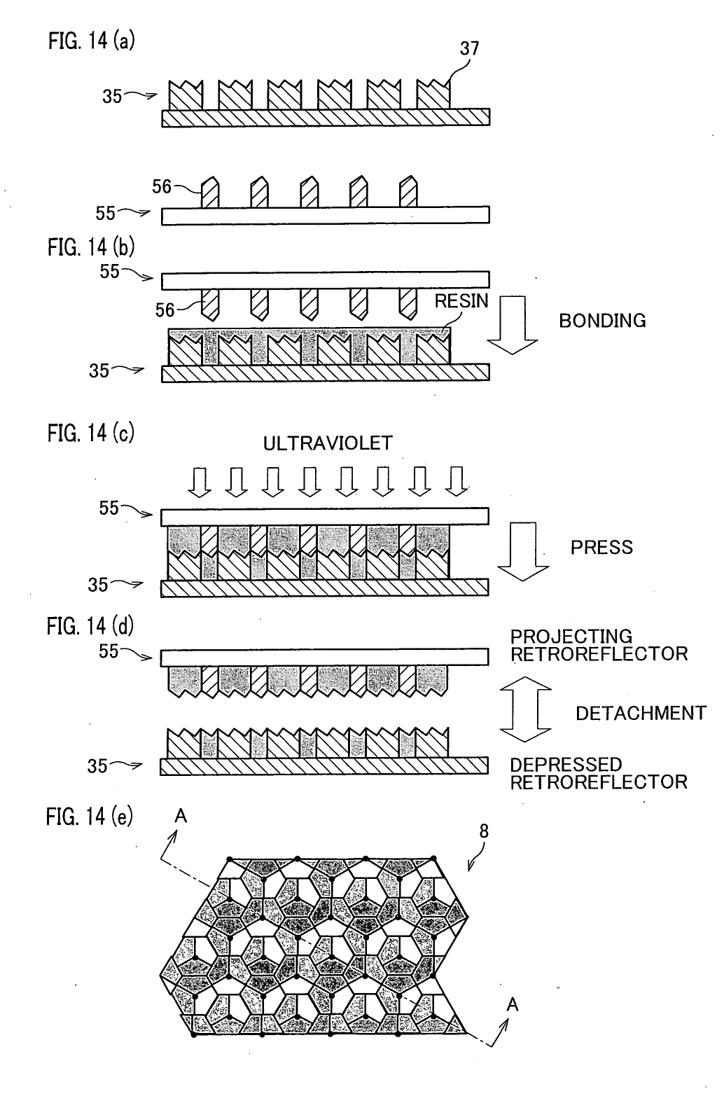

By the procedure of Step 11 through Step 16, the first inverted pattern (mold) 35 and the second inverted pattern (resin and glass pattern) 55 can be formed, as shown in FIG. 14(a). Note that, the cross sectional views of the first and second inverted patterns 35 and 55 shown in FIGS. 14(a) through 14(d) are taken along line A-A cutting the retroreflector 8 shown in FIG. 14(e).

Thereafter, as shown in FIG. 14(b), the resin (UV curable resin) used for the second inverted pattern 55 is applied over the entire surface of the first inverted pattern (mold) 35, filling the voids 36 (FIG. 11(c)).

Then, with the protruding hexagonal columns 56 of the second inverted pattern 55 mated and aligned with the voids 36 of the first inverted pattern 35, the first inverted pattern 35 and the second inverted pattern 55 are bonded together (Step 17).

Next, as shown in FIG. 14(c), the first inverted pattern 35 and the second inverted pattern 55 are pressed together, and the UV curable resin therebetween is cured by irradiation of UV light through the second inverted pattern 55 (Step 18).

Thereafter, the first inverted pattern 35 and the second inverted pattern 55 are separated from each other. As a result, the first inverted pattern 35 is obtained in which the surface configuration (protruding retroreflecting units) of the protruding hexagonal columns 56 of the second inverted pattern 55 has been transferred (inverted) onto the surface of the resin embedded in the voids 36 of the first inverted pattern 35, as shown in FIG. 14(d).

In this way, the surface of the first inverted pattern 35 can have the configuration of the retroreflector 8 shown in FIG. 1.

Here, the configuration of the retroreflecting units S of the first inverted pattern 35 has been transferred onto the surface of the resin embedded in the voids of the second inverted pattern 55. (The resin has the configuration of the protruding retroreflecting unit of the protruding triangular array.)

That is, the second inverted pattern 55 has the inverted pattern of the retroreflector 8.

The second inverted pattern 55 can be used as a master, and the inverted pattern can be formed by electrocasting (embedded plating) as in Step 4. In this way, the retroreflector 8 can be obtained.

The retroreflectance of the obtained retroreflector 8 was checked by a test device shown in FIG. 10 above, with the same result for the retroreflector 8 manufactured through the method shown in FIGS. 11(a) through 11(i) (it was 1.5 times the retroreflectance of depressed triangular array).

In this manufacturing method, the retroreflector 8 is produced by joining the first inverted pattern 35 in which the retroreflecting unit columns 37 are formed in an array manner (combined together) and the second inverted pattern 55 having the protruding hexagonal columns 56.

With this method, the manufacturing process is simplified compared to the formation of the retroreflector 8 by combining individual pieces of retroreflecting unit columns 27. Thus the manufacturing speed can be further accelerated.

Further, the protruding hexagonal columns 56 of the second inverted pattern 55 are made of the same material as that of the resin embedded in the void portion. Therefore, it is preferable to form a detachment layer on the end face of the protruding hexagonal column 56 before the first inverted pattern 35 and the second inverted pattern 55 are bonded together.

With this arrangement, security for detachment from the ultraviolet resin embedded in the void portion can be ensured. The detachment layer may be an Al thin film (200 Å) or the like.

In the foregoing example, the inverted pattern of the second inverted pattern 55 is used as the retroreflector 8. However, the present invention is not limited to this. For example, the retroreflector 8 may also be formed by the following way. An inverted pattern of the first inverted pattern 35 having the same patterns as those of the retroreflector 8 is first formed, and an inverted pattern of this inverted pattern is further formed with a metal material.

Further, by forming an inverted pattern of the first inverted pattern 35 using a transparent material, a transparent substrate having the same shape as that of the second inverted pattern 55 is created. This transparent substrate serves as the retroreflector 8 by being disposed with the rear surface facing the observer.

Further, in the foregoing manufacturing method, the surface of the first inverted pattern 35 has the same pattern as that of the retroreflector 8, and the surface of the second inverted pattern 55 has the same pattern as the transferred pattern of the retroreflector 8.

Accordingly, the ultraviolet-setting resin, which is applied on the first inverted pattern 35 in Step 17 shown in FIG. 14(b), preferably has an amount enough to fill the spaces among the retroreflecting unit columns 37 of the first inverted pattern 35 and the spaces among the protruding hexagonal columns 36 of the second inverted pattern 55.

Alternately, resist may be applied only in the spaces among the protruding hexagonal columns 36 of the second inverted pattern 55. This also creates the second inverted pattern 55 with a surface having the same pattern as the transferred pattern of the retroreflector 8.

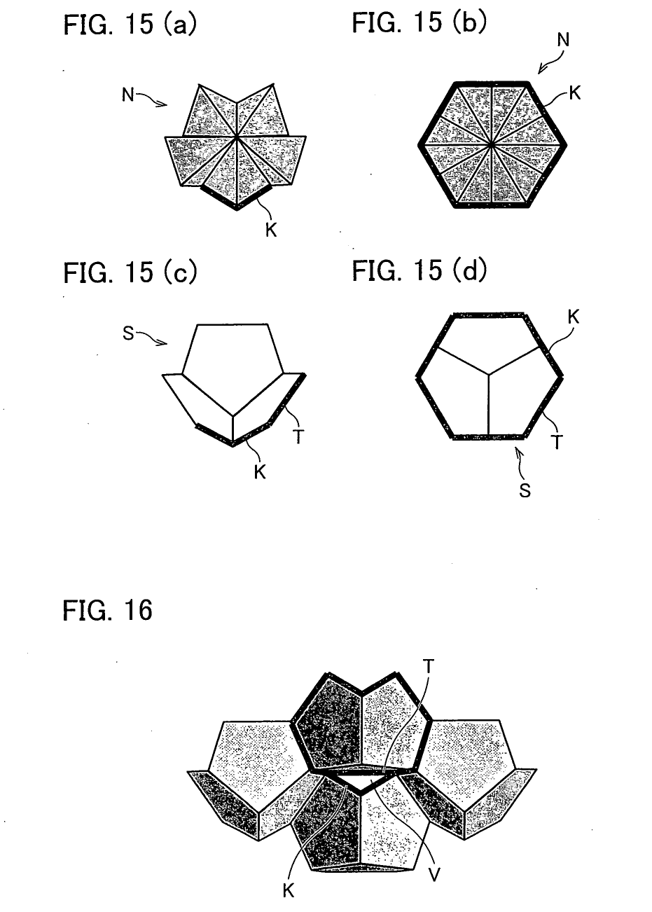

FIGS. 15(a) and 15(b) respectively show a perspective view and a plan view of the non-retroreflecting unit N of the depressed triangular array shown in FIG. 4. FIGS. 15(c) and (d) respectively show a perspective view and an upper view of the retroreflecting unit S.

As shown in FIGS. 15(a) and 15(b), each side of the hexagon forming the two dimensional shape of the non-retroreflecting unit N is constituted of a cross section (polygonal line K) formed on two different inclined planes.

On the other hand, as shown in FIGS. 15(c) and 15(d), each side of the hexagon forming the two dimensional shape of the retroreflecting unit S is constituted of a polygonal line K, which is similar to that of the non-retroreflecting unit N, and a “straight line T”, that is a cross section of a single plane (the polygonal line K and the straight line T alternately exist).

Further, on the depressed triangular array, the polygonal line K of the retroreflecting unit S is unified to the polygonal line K of the non-retroreflecting unit N without a gap.

Here, as shown in FIGS. 6 and 7, the retroreflector 8 has a structure in which the retroreflecting units S are so disposed as to fill the gaps generated as a result of removal of the non-retroreflecting units N from the depressed triangular array. Therefore, in the retroreflector 8, three of six polygonal lines K of the non-retroreflecting units N intersect with the straight line T.

Therefore, in the retroreflector 8, there is a portion where the polygonal line K of the retroreflecting unit S and the straight line T are opposed to each other. In this portion, there is a gap (void) V between the polygonal line K and the straight line T, as shown in FIG. 16.

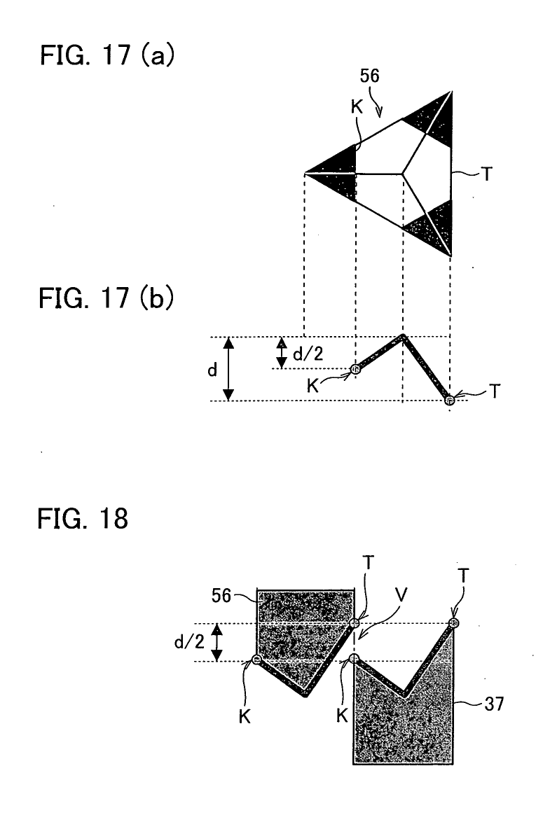

FIGS. 17(a) and 17(b) respectively show an upper view and a cross-sectional view of the surface (projecting retroreflecting unit) of the protruding hexagonal column 56 shown in FIG. 12(c).

As shown in these figures, the surface (projecting triangle) of the protruding hexagonal column 56 also has the polygonal line K and the straight line T. Further, in terms of the direction to which the protruding hexagonal column 56 extends (that is, when viewed in the direction normal to the base plate of the second inverted pattern 55), the distance from the polygonal line K to the apex is d/2, when the height of the projecting triangle (distance from the straight line T to the apex) is expressed as d (note that, d corresponds to the depth (height of projection/depression)) of the retroreflecting unit S.

Therefore, in Step 18 explained above with reference to FIG. 14(c), a gap V with a width=d/2 is generated between the protruding hexagonal column 56 of the second inverted pattern 55 and the retroreflecting unit column 37 of the first inverted pattern 35 (between the polygonal line K and the straight line T), as shown in FIG. 18.

Because of this gap V shown in FIG. 18(c), it may occur that the ultraviolet-setting resin existing between the protruding hexagonal columns 56 of the second inverted pattern 55 and the ultraviolet-setting resin existing between the retroreflecting unit columns 37 of the first inverted pattern 35 are unified via the gap V.

Further, in this case, when the first and second inverted patterns 35 and 55 are detached, the resin layers formed on them may be peeled off along with the detachment, thereby damaging the transferred pattern.

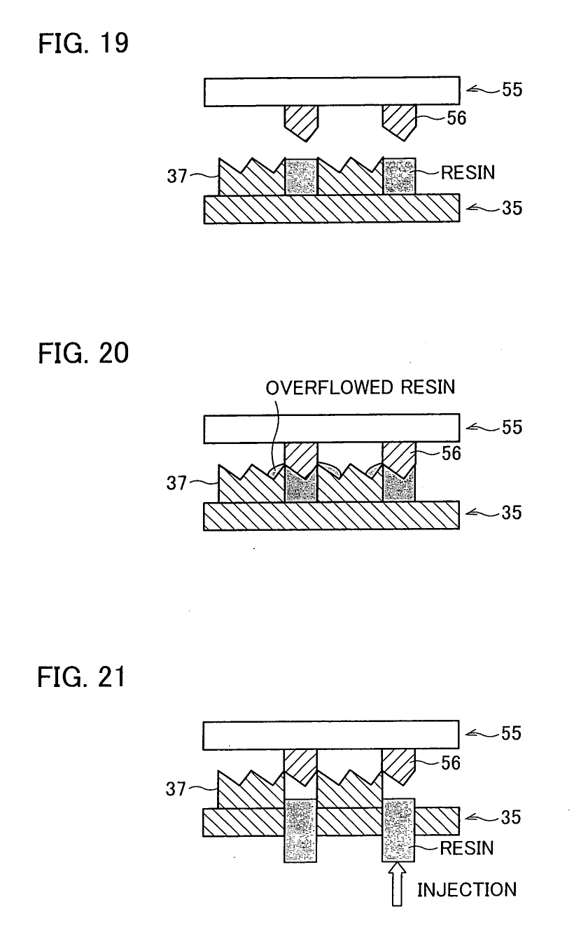

Furthermore, even if the ultraviolet resin is filled only between the retroreflecting unit columns 37 of the first inverted pattern 35 as shown in FIG. 19, the resin may leak from the gap V, and flows into the surface of the retroreflecting unit column 37, as shown in FIG. 20.

The transferred pattern of the retroreflector 8 may also be made on the surface of the second inverted pattern 55 in the following manner. First, a hole is made between each of the retroreflecting unit columns 37 by penetrating it through the first inverted pattern 35 before the inverted patterns 35 and 55 are superimposed, and then resin (pattern transfer material; ultraviolet-setting resin) is injected into the hole from the back surface of the first inverted pattern 35. This method is shown in FIG. 21.

However, this method is still not completely free from the leakage of resin shown in FIG. 20.

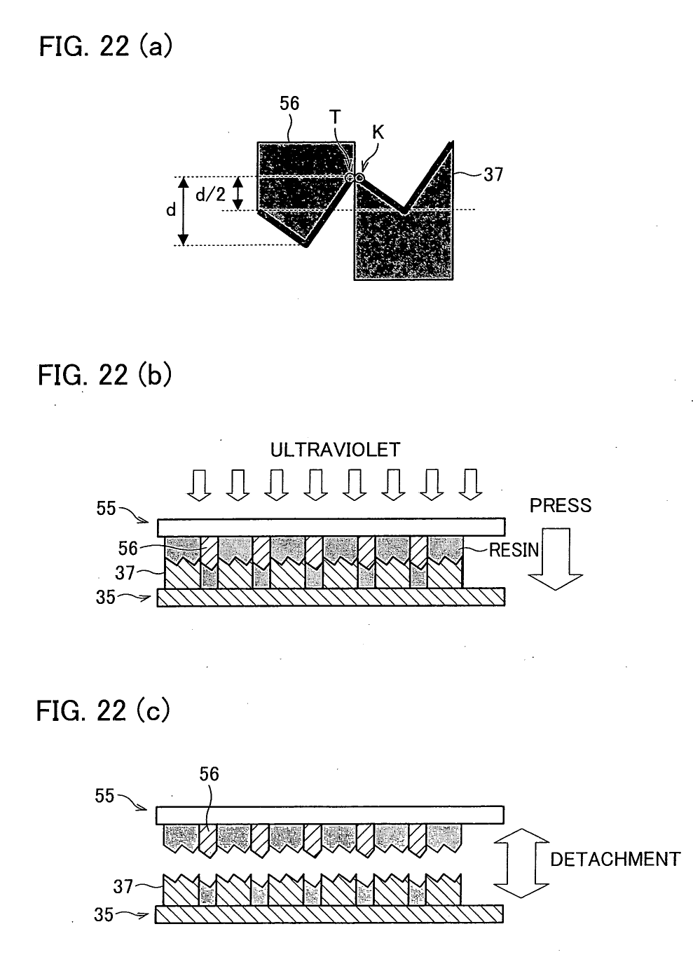

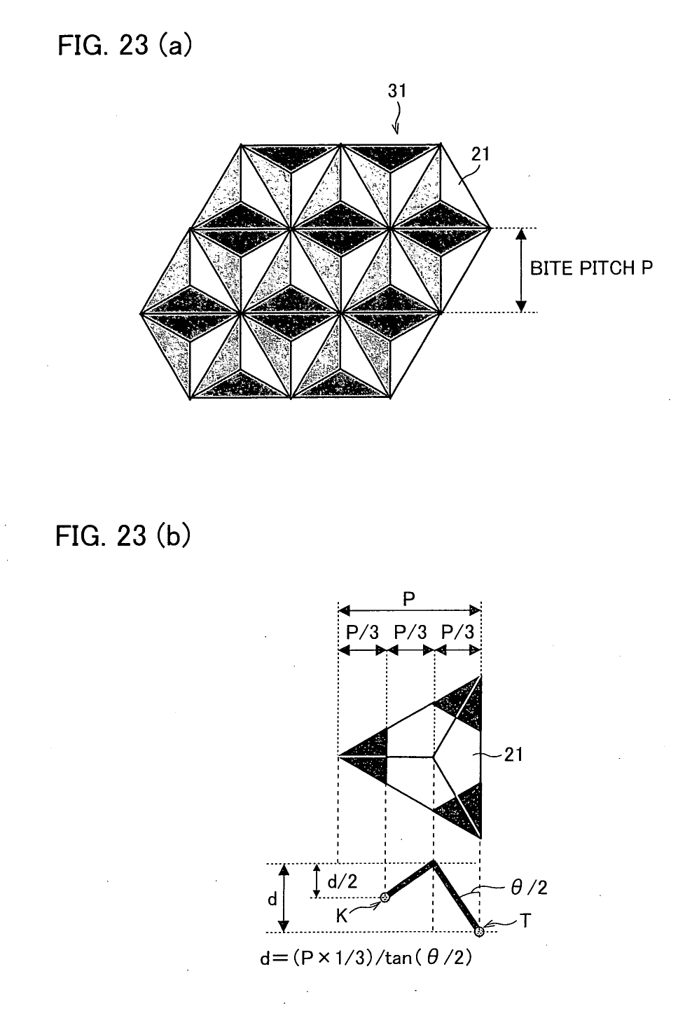

Therefore, in Step 18 shown in FIG. 14(c), it is preferable to deeply embed the protruding hexagonal columns 56 of the second inverted pattern 55, as shown in FIGS. 22(b) and 22(c).

More specifically, as shown in FIG. 22(a), the protruding hexagonal columns 56 is preferably embedded until the straight line T, which forms the two dimensional shape (protruding triangle) of the protruding hexagonal columns 56 of the second inverted pattern 55, comes in contact with the polygonal line K of the retroreflecting unit columns 37 of the first inverted pattern 35 (until the gap V disappears).

This can be ensured by embedding the protruding hexagonal columns 56 of the second inverted pattern 55 until its apex is inserted at least d/2 deeper than the bottom apex of the retroreflecting unit S, when the inverted patterns 35 and 55 are superimposed.

In this case, there is d/2 height difference between the protruding hexagonal column 56 of the second inverted pattern 55 and the height of the protruding triangle of the ultraviolet-setting resin existing between the protruding hexagonal columns 56.

Similarly, there also is the d/2 height difference between the retroreflecting unit column 37 of the first inverted pattern 35 and the depressed triangle of the ultraviolet-setting resin existing between the retroreflecting unit columns 37.

Such height differences may decrease the retroreflectance. However, it can prevent the ultraviolet-setting resin existing between the protruding hexagonal columns 56 of the second inverted pattern 55 from being unified with the ultraviolet-setting resin existing between the retroreflecting unit columns 37 of the first inverted pattern 35 via the gap V.

Therefore, it can prevent the resin layers formed on the first and second inverted patterns 35 and 55 from being peeled off along with the detachment of the first and second inverted patterns 35 and 55. On this account, the damage of transferred pattern can be avoided.

As described, the d/2 level difference (height difference in bottom apex) is generated between the surfaces of the inverted patterns 35 and 55 when the apex of the protruding hexagonal column 56 of the second inverted pattern 55 is inserted d/2 deeper than the bottom apex of the retroreflecting units S.

Here, when the protruding triangular array 31 in which the protruding triangles are closely packed, such as the one shown in FIG. 23(a), is subjected to cutting process with a bite pitch of 15 μm, d is 7 μm, making d/2 be 3.5 μm.

Accordingly, the height d of the protruding triangle shown in FIG. 23(b) is expressed as follows.
d=(P×⅓)/tan(θ/2)

(θ denotes apex of bite)

According to the fact that the apex θ of the bite=70.5°, d can be further expressed as follows.
d=7.07 . . . ≈7 (μm)

The present display device is generally arranged so that the gap between the incident-side substrate 6 and the reflection-side substrate 7 (see FIG. 2) is set to several μm to 10 μm, and the value of gap is set based on a unit of at or less than 0.5 μm. Therefore, the foregoing level difference of 3.5 μm is not always negligible.

Further, since the level difference in the retroreflector 8 becomes 1.5 times greater (d+d/2) in this case, it is not preferable in terms of manufacturing (the smaller difference, the better).

In view of this problem, the following explains another manufacturing method of the retroreflector 8 which ensures prevention of such a level difference and the leakage of resin from the void.

With the Steps 11 and 12, which were explained above with reference to FIGS. 11(a) and (b), the projecting triangle array 31 with the photoresist 22 only in the projecting non-retroreflecting unit is obtained.

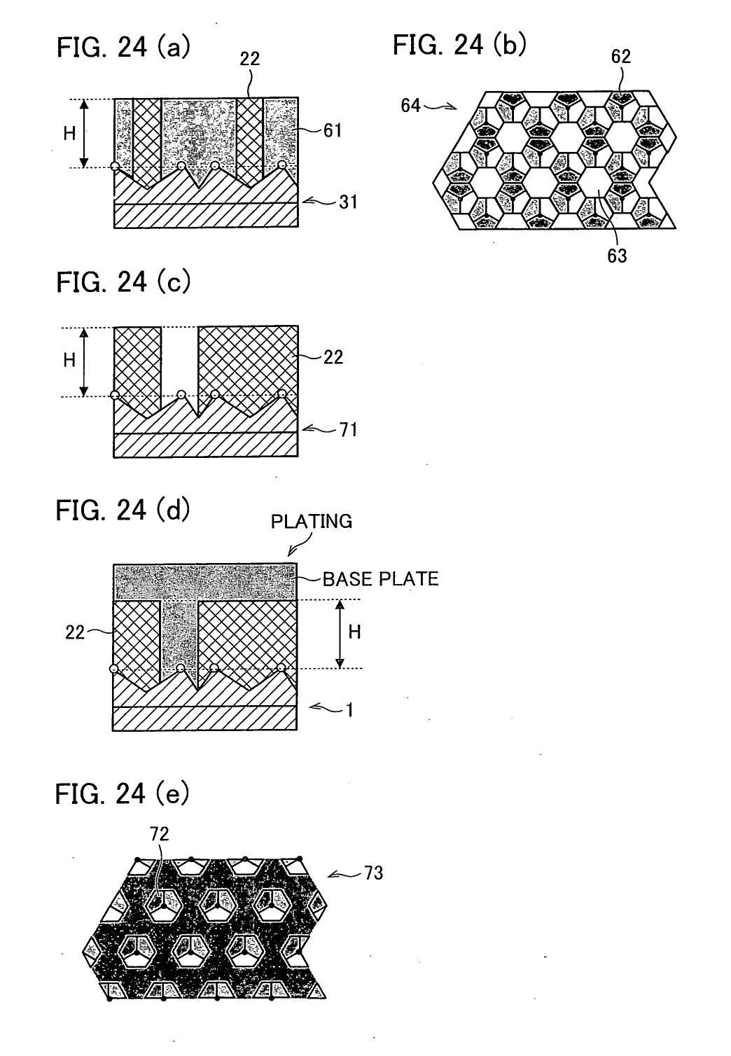

Then, plating is carried out for each space between the columns of photoresist 22 (Step 21). Here, as shown in FIG. 24(a), the thickness (H) of plating material 61 is adjusted to the same height as that of the photoresist 22.

Here, the thickness of the plating resist (thickness of the plating layer) is a thickness measured from the apex of the projecting triangle 21.

This can be ensured by adjusting the amount of the plating material 61 so that the thickness of the plating material 61 becomes equal to that of the resist 22. Otherwise, the plating material 61 is made thicker than the photoresist 61, and then polished to the same thickness as that of the resist 22.

Next, the plating material 61 is detached from the protruding triangle array 31 (Step 22).

As a result, as shown in FIG. 24(b), obtained is a first inverted pattern 64 with no base plate in which the retroreflecting unit column 62 having the end face of the retroreflecting units S is combined with the through hole 63.

In the first inverted pattern 64, the retroreflecting unit column 62 exists in a portion corresponding to the retroreflecting unit S of the depressed triangular array. Similarly, the through hole 63 is disposed in a portion corresponding to the non-retroreflecting units N.

Next, the resist 22 is applied to the projecting triangle array 71 having the same shape as the projecting triangle array 31. Then, the photoresist 22 is exposed through a photomask 52 shown in FIG. 12(d) and developed. As a result, on the projecting triangle array 71, the resist 22 is formed in the area other than the projecting retroreflecting units, according to the layout of the projecting non-retroreflecting units (Step 23).

Here, as shown in FIG. 24(c), the thickness of the resist 22 is adjusted to the same value as the thickness H of the plating material 61 (resist 22) shown in FIG. 24(a).

Next, as shown in FIG. 24(d), an inverted pattern of the projecting triangle array 71 is formed by electrotyping (embedding plating) (Step 24). Note that, a base plate is formed on this inverted pattern by plating.

As a result, as shown in FIG. 24(e), a second inverted pattern 73 is formed from a plating material. In this second inverted pattern 73, the retroreflecting unit column 72 having the same surface (end face) as that of the retroreflecting units S is disposed in the same manner as that of the non-retroreflecting units N of the depressed triangle array.

Further, the height of this retroreflecting unit column 72 is equal to the height of the retroreflecting unit column 62 of the first inverted pattern 64.

Next, the first inverted pattern 64 is overlaid on the second inverted pattern 73 by inserting the retroreflecting unit column 72 of the second inverted pattern 73 into the through hole 63 of the first inverted pattern 64.

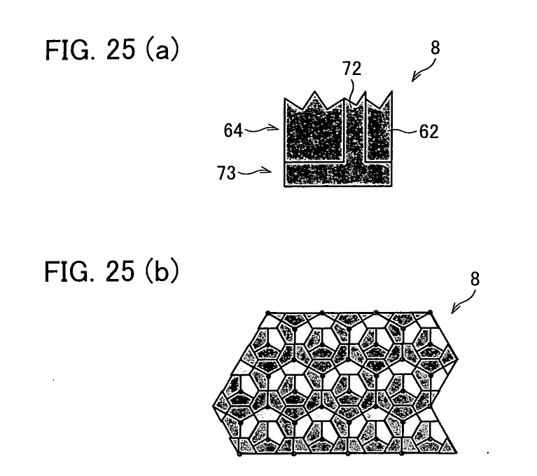

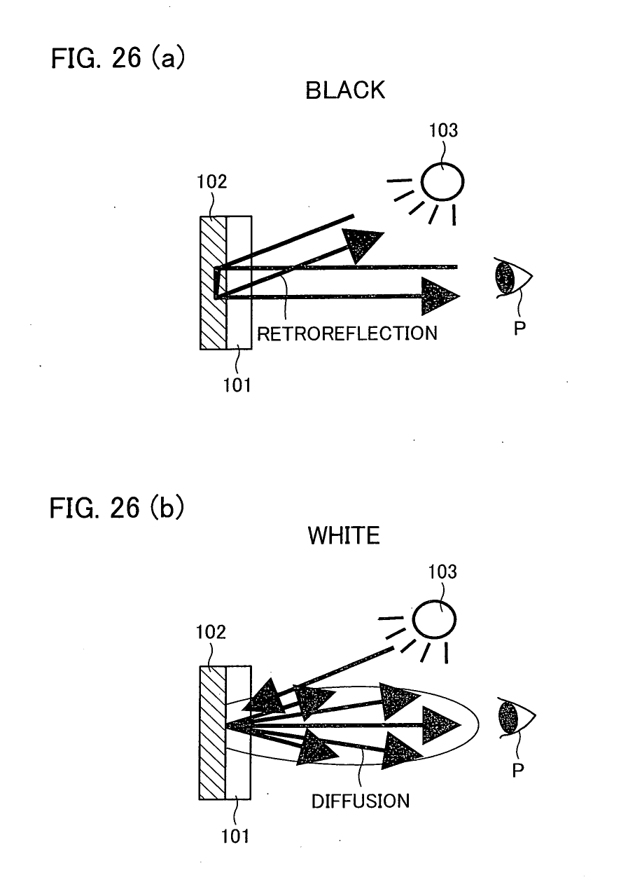

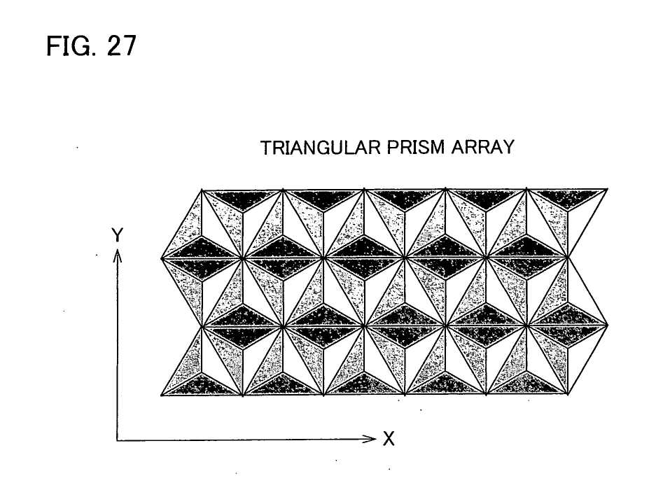

FIGS. 25(a) and 25(b) respectively show a cross-sectional view and an upper view of a state where the first inverted pattern 64 is overlaid on the second inverted pattern 73.

As described, the retroreflecting unit column 72 of the second inverted pattern 73 and the retroreflecting unit column 62 of the first inverted pattern 64 have the same height. Therefore, as shown in FIGS. 25(a) and 25(b), by superimposing the first and second inverted patterns 64 and 73, the resulting retroreflector 8 is constituted of the retroreflecting units S (the retroreflecting unit columns 72 and 73) all free from level difference.

Here, in the manufacturing method shown in FIGS. 24 and 25, the first inverted pattern 64 is combined with the second inverted pattern 73. However, the present invention is not limited to this. For example, the retroreflector 8 can be formed by inserting the retroreflecting unit column 27 shown in FIG. 8(i) into the retroreflecting unit column 62.

Further, in the present embodiment, as shown in FIGS. 14(b) through 14(d), FIGS. 19, 21, 22(b) (c), ultraviolet-setting resin, as a transfer material, is applied between the retroreflecting unit column 37 of the first inverted pattern 35 and the protruding hexagonal columns 56 of the second inverted pattern 55, and the shapes of end faces of the protruding hexagonal columns 56 and the retroreflecting unit column 37 are transferred.

Here, apart from the ultraviolet-setting resin, a thermosetting resin, a thermoplastic resin, or the like can be used for the transfer material as long as it ensures sufficient transfer property.

For example, a low-melting point metal or the like may be used as the transfer material. Particularly, in the manufacturing method explained with reference to FIG. 21, the plating material can also be used as the transfer material.

The following describes additional details of the fabrication method of the retroreflector 8. In addition to the material described above, any material (Ni, Cu, etc.) can be used for the photoresist used in Steps 2, 12, 15 and 23, and for the plating material used in Steps 4, 13, 21 and 24, as long as they ensure desirable pattern-transferring properties.

SU-8 (Kayaku Microchem) may be used as the photoresist. Further, if the plating is selectively carried out to any desired portions, the photoresist can be completely omitted.

Further, the plating (electrotyping) performed in the Steps 4, 13, 21, and 24 may instead be 2P method (photopolymer method) which uses an ultraviolet-setting resin. In this case, an example of the ultraviolet-setting resin material may be MP-107 (Mitsubishi Rayon).

Further, the device used for the foregoing cutting process may instead be other type of device as long as it ensures a necessary processing accuracy.

Further, the present invention is not limited to the foregoing structure in which the retroreflector 8 is provided in a reflective liquid crystal display device. For example, the retroreflector 8 may be provided in a luminous display element using an organic EL (Electro Luminescence) or the like. In this case, the retroreflector 8 is placed on the rear surface of the luminous layer of the display element.

In this structure, since the light emitted from the luminous layer is emitted toward the luminous display element, the superior white display with high brightness is realized. Further, the luminous layer obtains not only the light incident on the surface but also the light incident on the rear side, thus the light usage efficiency of incident light increases.

Further, because of the retroreflector 8, external incident light is reflected to the same direction as that it came from. This contributes to increase the display contrast when the luminous element is undergoing light emission. Further, even when the element is not emitting light, it is possible to prevent reflection of external light toward the observer, avoiding reflection of external objects in the display screen. Therefore a superior black display is realized.

The following minutely explains a measurement method of retroreflectance using an evaluation device shown in FIG. 10.

The sample (measurement sample) is constituted of a plurality of unit structures (e.g. triangular pyramid prism) two-dimensionally aligned. The sample is fixed to the sample stage 41. Then the light is emitted from the light source, and is reflected by the half mirror 43 and perpendicularly incident on the sample held on the sample stage 41 as it passes through the objective lens 42 (converging angle of 7.5°). Here, the light forms a beam spot (measurement spot; diameter D (1 mm, for example)) on the sample (measurement sample).

The incident light is reflected by the sample. Among the reflection light, the light substantially vertically reflected is received by a light-receiving section through the objective lens 42. Then, the light strength I1 of this light substantially vertically reflected is measured. Note that, the light reflected by the sample must have the retroreflection light. The retroreflection light designates reflection light generated when the light incident on the sample is reflected at least two planes of the plural planes constituting the unit structure of sample. The retroreflection light has a negative vector of the vector of incident light.

Next, instead of the sample, a dielectric mirror used as a reference is placed on the sample stage 41 of the test device. In the same manner as above, light is emitted from the light source, and is reflected by the half mirror 43 and perpendicularly incident on the dielectric mirror held on the sample stage 41 as it passes through the objective lens 42. The light substantially vertically reflected is received by the light-receiving section through the objective lens 42. Then, the light strength Ir of this light substantially vertically reflected is measured.

After that, the ratio (I1/Ir) (%) of the light strength I1 of reflection light by the sample to the light strength Ir of the reflection light by the dielectric mirror is measured. The ratio expresses a retroreflectance Rr of the sample.

In the foregoing evaluation, the strength I1 of the reflection light by the sample is measured before the strength Ir of the reflection light by the dielectric mirror is measured. However, the strength Ir may be measured first.

The foregoing evaluation assumes, as the object of evaluation, a retroreflector used for a display panel made in view of personal use. In this display panel, the alignment pitch of the retroreflector is set at or less than the pixel pitch of the display panel. Therefore, to be more specific, the alignment pitch of sample evaluated by this evaluation method should be set at or less than 250 μm, more preferably at or less than 20 μm.

To carry out highly-reliable evaluation with the foregoing test device, the diameter D of the beam spot formed on the sample by the light emitted from the light source is preferably adjusted at or greater than the alignment pitch of the unit structure of the sample. If the diameter D of the beam spot on the sample is smaller than the alignment pitch of the unit structure, the measurement value of the retroreflectance Rr greatly varies depending on the portion of the beam spot formed on the sample. More specifically, the retroreflectance Rr increases when the beam spot is formed in the center of the unit structure, and decreases when the beam spot is formed in the vicinity of the periphery (unction between the plural unit structure) of the unit structure since the retroreflection light tends to miss the light receiving section. Therefore, it is not possible to attain a desirable accuracy in evaluation of the retroreflection property of the sample.

Therefore, the diameter D of the beam spot is preferably three times greater than the alignment pitch. By ensuring this, the position of the beam spot or the variation in retroreflection for each unit structure less affect the measurement value of the retroreflectance Rr. Therefore, the reliability in the evaluation increases.

Further, the converging angle of the objective lens is not limited to the value above. The value should be appropriately set to obtain the preferred size of beam spot.

If the converging angle becomes greater than 20°, the beam spot in the measurement sample becomes smaller, and the measurement value of the retroreflectance varies depending on the position of beam spot. Further, in this case, it is more likely that the return light (diffusion component etc.), which did not undergo retroreflection, is also be converged by the objective lens.

The foregoing evaluation method is not suitable for evaluation of retroreflector constituted of excessively-large unit structures, such as a road sign or the like. This is because such a retroreflector has a difficulty in forming a beam spot of appropriate size. However, when the diameter D of beam spot is increased to a desired level by creating the specially-large objective lens 42, the problem will be solved.

The following is another way to describe the present invention. The retroreflecting region in the depressed triangle array forms a hexagon having three common sides to the regular triangle constituting the depressed triangle, and the remaining region (regular triangle) including the corners of the regular triangle functions as a non-retroreflecting region. However, when plural depressed triangle arrays are disposed in an array manner, the respective non-retroreflecting regions of adjacent triangular pyramids come in contact with each other, forming a hexagon. Here, this hexagon in the non-retroreflecting region and the hexagon in the retroreflecting region are congruent with each other (the actual figure is constituted of three sides of a pentagon having 90° apex (corresponding to the bottom apex), as shown in FIG. 4 etc.) in an upper view such as FIG. 3. Therefore, by removing the non-retroreflecting region, a void portion to which the retroreflecting region is inserted is formed (FIG. 7).

Then, the pattern of retroreflecting region is embedded in the void portion, creating a retroreflector whose entire area has retroreflecting property, as shown in FIGS. 7 and 8. More specifically, by highly-densely filling each unit of void constituted of three sides of the pentagon having 90° apex angle (the apex angle here means a bottom apex (apex) in a plane constituting the unit structure of retroreflector), it is possible to form a retroreflector whose entire area has retroreflecting property (a unit structure of this retroreflector is formed by the cutting process shown in FIG. 28(a)).

Further, the retroreflector 8 is measured by the evaluation device (measurement device) shown in FIG. 10, also measuring a depressed triangular array as a reference. The result was 150% with respect to the reference. The value corresponds to the planar dimension ratio of the retroreflecting region between the depressed triangle array and the retroreflector 8. This proves that 100%, that is the entire area of the retroreflector 8 has retroreflecting property, with a retroreflectance sufficient for a display device.

Further, the retroreflector of the present invention is formed by highly-densely filling each unit of void constituted of three sides of the pentagon having 90° apex angle (the apex angle here means a bottom apex (apex) in a plane constituting the unit structure of retroreflector). The unit structure is a part of the depressed triangle array obtained by the cutting process shown in FIG. 28(a). More specifically, the disused part of the projecting triangle is masked, and only the used part is transferred, thus creating a unit structure of retroreflector constituted of a pentagon.

Further, as described, in spite of the difference in alignment density, the figures of the non-retroreflecting region and the retroreflecting region of the depressed triangle array are identical to each other (when viewed from above). Also, the alignment density of the retroreflecting region is twice larger than that of the non-retroreflecting region, and the alignment of the non-retroreflecting region is subsumed in that of the retroreflecting region. This more specifically explains with reference to FIGS. 13(a) and 13(b). The retroreflecting regions and the non-retroreflecting regions are aligned as shown in FIG. 13(a). Here, by moving the non-retroreflecting region in parallel by 1 pitch (of hexagon) in the direction denoted by the arrow, the non-retroreflecting becomes flush with the retroreflecting region. On this account, by changing the position of the hexagon pattern of the non-retroreflecting region, it is possible to obtain the retroreflecting regions aligned in the same manner as that of the non-retroreflecting regions.

Therefore, by using a photomask shown in FIG. 12(d) in the photolithography step, it is possible to obtain an array of the retroreflecting regions which are aligned at the same density as that of the non-retroreflecting regions.

Further, the figure of the second inverted patterns 55 are all formed by the same resin material, and therefore each surface of the second inverted pattern 55 preferably has a detachment layer for ensuring detaching property from the ultraviolet-setting resin (applied between the patterns). A detachment layer of Al thin film (200 Å) not only ensures detaching property but also maintains the figure of the second inverted pattern 55.

Further, in the method shown in FIGS. 11 through 14, it is possible to simultaneously obtain the depression and the projection of the retroreflector 8. For the retroreflector 8 to serve as a retroreflector, as with the triangular pyramid, the intersection (this is hereinafter referred to as an “apex” of a component of unit structure) of apices (the apices of 90° C.) of the pentagon needs to have either a layout of “depression+high-reflective metal” or a layout of “projection+observation from rear side”. To create these layouts, the figure produced through the subsequent steps (e.g. FIGS. 11-14) can be used as a master form. If a die is made first and then the product is made through a transfer process (when the form obtained in an even numbered step is used as a product), the final product may be used as a master form, and if another transfer step is performed (when the form obtained in an odd numbered step is used as a product), the inverted form of the final product can be used as a master form.

Further, in the triangular pyramid prism array, the retroreflecting regions and the non-retroreflecting regions are mixed. FIG. 15 shows a comparison between a unit structure of the retroreflecting region and a unit structure of the non-retroreflecting region. As shown in FIG. 15, the upper views of them are completely identical hexagons, and therefore are replaceable by patterning and superimposition. However, when the unit structures are viewed from an oblique direction, the respective sides of hexagon is formed by a cross section (hereinafter referred simply as a polygonal line) formed on two different inclined planes. On the other hand, “the non-retroreflecting region” is constituted of an alternate structure of a polygonal line and a straight line, that is a cross section of a single plane. Therefore, as shown in FIG. 16, the figure resulting from removal of the non-retroreflecting region and the figure of the retroreflecting region placed in the void both certainly look hexagons when viewed from above, but the hexagon in the void has sides of polygonal lines and the hexagon of the repositioned retroreflecting region has an alternate structure of a polygonal line and a straight line. That is, though the polygonal lines coincide with each other, the junction between the polygonal line and a straight line forms a void portion. FIG. 17 shows a cross section of the void portion. According to the figure, the void is generated through the method of FIGS. 11 through 14, and may cause a problem shown in FIGS. 19 through 21.

First, the upper resin and the lower resin resulted from the detachment are connected via the void portion, thereby causing deterioration of transfer shape because of detachment failure or coarse detaching. Further, as with the case of FIG. 19, when embedding and bonding the transfer resin (in a required volume) only in the portion originally served as the non-retroreflecting region, or when processing the portion corresponding to the non-retroreflecting region into a hole which penetrates to the rear surface, and then injecting the shape transfer material from the hole in the rear surface, there is a concern for the problem of the leakage of the transfer material from the “void portion”. According to the FIG. 17, if the height of the triangular pyramid is expressed as d, the lowest point generated by the polygonal line exists at d/2. Therefore, by crushed down the layer by a length corresponding to d/2 when the upper and lower dies are joined, the void portion is not generated, and the problem of FIG. 20 does not occur.

Further, in the method shown in FIGS. 22(a) through 22(c), the problem of “void portion” is solved but local level difference of d/2 is generated in the plane of the resulting retroreflector. Here, assuming that a triangular pyramid prism manufactured through a cutting step with a bite pitch of 15 μm is used as the retroreflector 8, which serves as a rear substrate of a liquid crystal display, the substrate locally has about 3.5 μm level difference. Considering the fact that the substrates in the liquid crystal display has a gap of several μm to 10 μm, and the gap size is controlled by a unit of not more than 0.5 μm, a level difference of 3.5 μm is far too large. Further, when the depression/projection of the retroreflector is flattened, the local level difference of 1.5 times greater than that of the retroreflector may be a hindrance in manufacturing.

As described, a retroreflector according to the present invention (the present reflector) reflects incident light back along an incident path, wherein a light reflecting surface of the retroreflector is defined by a configuration of closely packed retroreflecting units of a depressed triangular array.

The reflector of the present invention, which is used for a reflective display device (e.g. liquid crystal display device) or the like, reflects incident light back along an incident path (so that the light goes back along the incident path).

As a particularly notable feature, the reflector of the present invention is arranged so that a light reflecting surface of the retroreflector is defined by a configuration of closely packed retroreflecting units of a depressed triangular prism array (depressed triangular array).

That is, the depressed triangular array is made up of closely packed depressed triangular pyramid prism (depressed triangles) (in other words, hollow triangular-prisms are closely packed on a plane with the apices pointing downward).

Further, as described, ⅓ of the light reflecting surface of the triangular-pyramid array functions as the non-retroreflection region and ⅔ thereof functions as the retroreflection region.

More specifically, in the depressed triangular array, a hexagon region around the bottom apex of a triangular pyramid forms a unit structure (retroreflecting unit) of the retroreflecting region.

Further, the retroreflecting unit is constituted of three pentagons each having an apex angle of 90°.

Meanwhile, the non-retroreflecting area of the depressed triangle array is constituted of a unit structure (non-retroreflecting unit) around the junction of adjacent six depressed triangles (their apices are in contact with each other). The non-retroreflecting area is a hexagon congruent to the retroreflecting unit in a plan view (when the depressed triangular array is viewed from the normal direction).

Therefore, the depressed triangular array can be expressed as a structure made up of closely packed non-retroreflecting unit and the retroreflecting unit both having a hexagon shape.

Here, by removing the non-retroreflecting unit from the depressed triangular array, the array becomes a configuration made up of retroreflecting units and void portions.

Further, placing the retroreflecting units in the portions of the depressed triangular array from which non-retroreflecting regions have been removed produces the reflector of the present invention, which is entirely constituted of retroreflecting units.

With this configuration, the retroreflector of the present invention has a surface made up of closely packed retroreflecting units of the depressed triangular array. That is, in the retroreflector of the present invention, the entire surface is constituted of retroreflecting units, in other words, the entire surface functions as a retroreflecting region.

The retroreflector of the present invention therefore has a significantly high retroreflectance.

The retroreflector of the present invention is preferably arranged so that the retroreflecting units are raised to a uniform height on the light reflecting surface.

This arrangement achieves further higher retroreflectance. Moreover, when the retroreflector is used in a display device, productivity of the display device increases.

The following steps (4-1) through (4-3) are an example of manufacturing method of such a retroreflector.

(4-1) forming a resist only in non-retroreflecting regions of a protruding triangular array in which protruding triangles are closely packed together;

(4-2) filling a transfer material between the resists formed on the protruding triangular array, so as to transfer and form a plurality of retroreflecting unit columns having the same end face configuration as retroreflecting units; and

(4-3) closely packing the retroreflecting unit columns with the end faces aligned together.

Here, the projecting triangle array is obtained by transferring the depressed triangle array. Further, the non-retroreflecting region of the projecting triangle array denotes a portion which becomes a retroreflecting unit of the depressed triangle array when transferred. Similarly, the non-retroreflecting region of the projecting triangle array denotes a portion which becomes a non-retroreflecting unit of the depressed triangle array when transferred.

In the step (4-1) the non-retroreflecting region of the projecting triangular array is covered by resist. Then, in the subsequent step (4-2) the retroreflecting region having no resist in the projecting triangular array is filled with a transfer material. The transfer material is then hardened to become a hexagon column (retroreflecting unit column) which contains an end face of the transferred shape (the retroreflecting unit) of the retroreflecting unit of the projecting triangular array.

Therefore, as shown in the step (4-3), a plurality of retroreflecting unit columns are formed, and then closely packed by joining their end faces, thereby forming a retroreflector whose entire reflection surface functions as a retroreflecting unit.

The following steps (5-1) through (5-3) are another example of manufacturing method of the retroreflector.

(5-1) forming a first retroreflecting unit array in which retroreflecting unit columns having the same end face configuration as retroreflecting units of a depressed triangular array are arranged in the same layout as the retroreflecting units of the depressed triangular array, and in which voids are formed between the retroreflecting unit columns;

(5-2) forming a transfer array in which protruding hexagonal columns having the same end face configuration as a retroreflecting region of a protruding triangular array are arranged in the same layout as non-retroreflecting units of the depressed triangular array; and

(5-3) transferring the end face configuration of the protruding hexagonal columns of the transfer array to an end face of a transfer material placed in the voids of the first retroreflecting array, so as to form retroreflecting units.

In this method, the step (5-1) first forms an array (first retroreflecting unit array), that is a depressed triangular array, but the non-retroreflecting units are all removed.

As a concrete example, the first retroreflecting array is formed by a transfer process, in which a resist is formed only in non-retroreflecting regions of a protruding triangular array, and in which a transfer material is filled between the resists.

Then, the step (5-2) forms a transfer array constituted of projecting hexagon columns having the same end faces as those of the retroreflecting regions of the projecting triangular array.

As a concrete example, the transfer array is formed by a transfer process, in which a resist is formed only in regions of the depressed triangular array other than the retroreflecting units corresponding to the layout of the non-retroreflecting units of the depressed triangular array.

Next, in the step (5-3), the end face shape of the projecting hexagon column of transfer array is transferred to the end face of the transfer material placed in the void of the first retroreflecting unit array. As a result, the end faces of the transfer materials between the respective retroreflecting unit columns also function as retroreflecting units, making the entire surface of the first retroreflecting unit array function as a retroreflecting unit.

In this method, the retroreflector of the present invention is formed by combining a retroreflection unit column and the transfer array. This method is much simpler and speedy than the method of joining separate retroreflecting units.

The foregoing combining may also be carried out by placing the first retroreflecting unit and the transfer array so that the void portion and the projecting hexagon column are opposite to each other, then bonding the two arrays, and then filing the transfer material in the void portions of the first retroreflecting unit. With this method, by removing the transfer array, the entire surface of the first retroreflecting unit functions as a retroreflecting unit.

In this case, the void portions of the first retroreflecting unit are preferably formed as through holes (the both ends of the hole are opened). This arrangement allows the transfer material to be injected from the rear side of array (from the side not facing to the transfer array).

Further, the step (5-3) may also be carried out as follows. The transfer material is first injected to the void portions of the first retroreflecting unit, and then the first retroreflecting unit and the transfer array are placed so that the void portion and the projecting hexagon column are opposite to each other, and are bonded together.

Alternately, the transfer material may be injected also between the respective projecting hexagon columns of the transfer unit, and then the end faces of the retroreflecting unit array of the first retroreflecting unit array may be transferred to the transfer material portions.

With this method, the transfer unit can be used as a transfer format of the reflector of the present invention.

Therefore, the unit may be used as the original form of the reflector of the present invention.

When equalizing the position (height) of the retroreflecting unit used as a transfer material with the position (height) of the retroreflecting unit of the retroreflecting unit column in the bonding of the first retroreflecting unit and the transfer array, a gap is generated between the end face of the projecting hexagon column and the retroreflecting unit of the retroreflecting unit column because of the insertion of the projecting hexagon column between the respective retroreflecting unit columns (the embodiments below more specifically describes this problem).

Therefore, the transfer material may seep out through the gap into the face of the retroreflecting unit of the retroreflecting column.

Further, to avoid this leakage of transfer material, it is preferable, when the first retroreflecting unit array and the transfer array are bonded together, to embed the apices of the projecting hexagon columns of the transfer array equally to or deeper than d/2 (d denotes depth of retroreflecting unit).

With this arrangement, the generation of gap can be prevented.

Note that, though the deep insertion of the projecting hexagon columns prevents the leakage of transfer material, there arises a height difference between the retroreflecting unit formed of the transfer material and the retroreflecting unit of the retroreflecting unit column (height difference between their bottom apices).

This results in height variation among the retroreflecting units of the light reflecting surface of the retroreflector of the present invention.

In view of this problem, the following steps (12-1) through (12-3) are still another example of manufacturing method of such a retroreflector.

(12-1) forming a first retroreflecting unit array in which retroreflecting unit columns having the same end face configuration as retroreflecting units of a depressed triangular array are arranged in the same layout as the retroreflecting units of the depressed triangular array, and in which voids are formed between the retroreflecting unit columns;

(12-2) forming a plurality of retroreflecting unit columns having the same end face configuration as the retroreflecting units; and

(12-3) inserting the retroreflecting unit columns formed in said step (12-2) into the voids of the first retroreflecting unit columns.

In this method, the retroreflector of the present invention is formed by inserting a retroreflecting unit column into the void portion of the first retroreflecting unit array. Therefore, the transfer array is not used, and therefore the leakage of transfer material does not occur. Further, the height of the retroreflecting unit does not need to be adjusted.

Note that, the step (12-2) may also be carried out as follows. The retroreflecting unit columns are formed in the same layout as non-retroreflecting units of the depressed triangular array, so as to form a second retroreflecting unit array.

Thus, the second retroreflecting unit array may be made through a transfer process in which a resist is formed only in regions of the depressed triangular array other than the retroreflecting units corresponding to the layout of the non-retroreflecting units of the depressed triangular array, then injecting the transfer material between the respective resist regions, and then solidifying the transfer material.

In this case, in the step (12-3), the first retroreflecting unit array and the second retroreflecting unit array are combined together.

With this method, it is not necessary to individually insert the retroreflection unit columns into the void portions of the first retroreflecting unit. This method is therefore much simpler and speedy.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A retroreflector for reflecting incident light back along an incident path, wherein a light reflecting surface of the retroreflector is defined by a configuration of closely packed retroreflecting units of a depressed triangular array.

2. The retroreflector as set forth in claim 1, wherein the retroreflecting units are raised to a uniform height on the light reflecting surface.

3. A display device comprising:
a retroreflector for reflecting incident light back along an incident path, wherein a light reflecting surface of the retroreflector is defined by a configuration of closely packed retroreflecting units of a depressed triangular array.

4. A manufacturing method of a retroreflector for reflecting incident light back along an incident path,
said method comprising the steps of:
(4-1) forming a resist only in non-retroreflecting regions of a protruding triangular array in which protruding triangles are closely packed together;
(4-2) filling a transfer material between the resists formed on the protruding triangular array, so as to transfer and form a plurality of retroreflecting unit columns having the same end face configuration as retroreflecting units; and
(4-3) closely packing the retroreflecting unit columns with the end faces aligned together.

5. A manufacturing method of a retroreflector for reflecting incident light back along an incident path,
said method comprising the steps of:
(5-1) forming a first retroreflecting unit array in which retroreflecting unit columns having the same end face configuration as retroreflecting units of a depressed triangular array are arranged in the same layout as the retroreflecting units of the depressed triangular array, and in which voids are formed between the retroreflecting unit columns;
(5-2) forming a transfer array in which protruding hexagonal columns having the same end face configuration as a retroreflecting region of a protruding triangular array are arranged in the same layout as non-retroreflecting units of the depressed triangular array; and
(5-3) transferring the end face configuration of the protruding hexagonal columns of the transfer array to an end face of a transfer material placed in the voids of the first retroreflecting array, so as to form retroreflecting units.

6. The method as set forth in claim 5, wherein, in said step (5-1), the first retroreflecting array is formed by a transfer process, in which a resist is formed only in non-retroreflecting regions of a protruding triangular array, and in which a transfer material is filled between the resists.

7. The method as set forth in claim 5, wherein, in said step (5-2), the transfer array is formed by a transfer process, in which a resist is formed only in regions of the depressed triangular array other than the retroreflecting units corresponding to the layout of the non-retroreflecting units of the depressed triangular array, and a transfer material is filled between the resists.

8. The method as set forth in claim 5, wherein, in said step (5-3), the voids of the first retroreflecting unit array are filled with the transfer material after the first retroreflecting unit array and the transfer array are bonded together with the voids of the first retroreflecting unit array and the protruding hexagonal columns of the transfer array facing each other.

9. The method as set forth in claim 5, wherein, in said step (5-3), the first retroreflecting unit array and the transfer array are bonded together after filling the transfer material in the voids of the first retroreflecting unit array, with the transfer material and the protruding hexagonal columns of the transfer array facing each other.

10. The method as set forth in claim 9, wherein, in said step (5-3), the transfer material is filled between the protruding hexagonal columns of the transfer array, so as to transfer the end faces of the retroreflecting unit columns of the first retroreflecting unit array.

11. The method as set forth in claim 8, wherein, in bonding the first retroreflecting unit array and the transfer array together, the protruding hexagonal columns of the transfer array are inserted so that an apex of each protruding hexagonal column is beyond a bottom apex of each retroreflecting unit of the retroreflecting unit columns by a distance d/2, where d is a depth of the retroreflecting units.

12. The method as set forth in claim 9, wherein, in bonding the first retroreflecting unit array and the transfer array together, the protruding hexagonal columns of the transfer array are inserted so that an apex of each protruding hexagonal column is beyond a bottom apex of each retroreflecting unit of the retroreflecting unit columns by a distance d/2, where d is a depth of the retroreflecting units.

13. A manufacturing method of a retroreflector for reflecting incident light back along an incident path,
said method comprising the steps of:
(12-1) forming a first retroreflecting unit array in which retroreflecting unit columns having the same end face configuration as retroreflecting units of a depressed triangular array are arranged in the same layout as the retroreflecting units of the depressed triangular array, and in which voids are formed between the retroreflecting unit columns;
(12-2) forming a plurality of retroreflecting unit columns having the same end face configuration as the retroreflecting units; and
(12-3) inserting the retroreflecting unit columns formed in said step (12-2) into the voids of the first retroreflecting unit columns.

14. The method as set forth in claim 13,
wherein, in said step (12-2), the retroreflecting unit columns are formed in the same layout as non-retroreflecting units of the depressed triangular array, so as to form a second retroreflecting unit array, and
wherein, in said step (12-3), the first retroreflecting unit array and the second retroreflecting unit array are combined together.
